(19) United States
(12) Patent Application Publication
(10) Pub. No.: US 2008/0152082 A1
(43) Pub. Date: Jun. 26, 2008

(54) METHOD AND APPARATUS FOR USE IN SECURITY SCREENING PROVIDING INCREMENTAL DISPLAY OF THREAT DETECTION INFORMATION AND SECURITY SYSTEM INCORPORATING SAME

(76) Inventors: Michel BOUCHARD, Sainte-Foy (CA); Dan Gudmundson, Quebec (CA); Luc Perron, Charlesbourg (CA)

Correspondence Address: FETHERSTONHAUGH - SMART & BIGGAR, 1000 DE LA GAUCHETIERE WEST, SUITE 3300, MONTREAL, QC, H3B 4W5, omitted

(21) Appl. No.: 11/780,773

(22) Filed: Jul. 20, 2007

Related U.S. Application Data
(63) Continuation-in-part of application No. 11/694,338, filed on Mar. 30, 2007.
(60) Provisional application No. 60/822,559, filed on Aug. 16, 2006.
(60) Provisional application No. 60/865,276, filed on Nov. 10, 2006.

(30) Foreign Application Priority Data
Mar. 30, 2007 (CA) 2,583,557

(51) Int. Cl. G01N 23/04

(52) U.S. Cl. 378/57

(57) ABSTRACT

An apparatus, method and system for facilitating visual identification of a threat in an image during security screening are provided. Data derived from an apparatus that scans the receptacle with penetrating radiation conveying an image of the contents of a receptacle is received. The data conveying the image of the contents of the receptacle is processed to derive an area of interest in the image, the area of interest potentially containing a threat. First threat information conveying the area of interest in the image is then displayed on a display device while the area of interest in the image is processed to derive second threat information associated to the receptacle. The second threat information is then displayed on the display device such that the second threat information is displayed subsequently to the displaying of the first threat information. In alternative implementations, an apparatus, method and system for use in screening a person for facilitating visual identification of a threat located on the person is provided.

### CROSS-REFERENCES TO RELATED APPLICATIONS

This application is a continuation-in-part application claiming the benefit of priority under 35 USC §120 of U.S. patent application Ser. No. 11/694,338 filed Mar. 30, 2007 by Dan Gudmundson et al. and presently pending. The contents of the above-mentioned patent application are incorporated herein by reference.

This application also claims the benefit of priority under 35 USC §119e) of:
U.S. provisional patent application Ser. No. 60/822,559 filed Aug. 16, 2006 by Michel Bouchard and presently pending; and
U.S. provisional patent application Sr. No. 60/865,276 filed Nov. 10, 2006 by Michel Bouchard and presently pending.

The contents of the above-mentioned patent applications are incorporated herein by reference.

### FIELD OF THE INVENTION

The present invention relates generally to security systems and, more particularly, to a method and apparatus for use in screening luggage items, mail parcels, cargo containers or persons providing incremental display of threat detection information to identify certain threats and to a system incorporating such method and/or apparatus.

### BACKGROUND

Security in airports, train stations, ports, mail sorting facilities, office buildings and other public or private venues is becoming increasingly important in particular in light of recent violent events.

Typically, security-screening systems at airports make use of devices generating penetrating radiation, such as x-ray devices, to scan individual pieces of luggage to generate an image conveying the contents of the luggage. The image is displayed on a screen and is examined by a human operator whose task it is to identify, on the basis of the image, potentially threatening objects located in the luggage.

A deficiency with current systems is that they are mainly reliant on the human operator to identify potentially threatening objects. However, the performance of the human operator greatly varies according to such factors as poor training and fatigue. As such, the process of detection and identification of threatening objects is highly susceptible to human error. Another deficiency is that the images displayed on the x-ray machines provide little, if any, guidance as to what is being observed. It will be appreciated that failure to identify a threatening object, such as a weapon for example, may have serious consequences, such as property damage, injuries and human deaths.

Consequently, there is a need in the industry for providing a device for facilitating visual identification of a prohibited object in an image during security screening that alleviates at least in part the deficiencies of the prior art.

### SUMMARY OF THE INVENTION

In accordance with a broad aspect, the invention provides a method for facilitating visual identification of a threat in an image during security screening. The method comprises receiving data conveying an image of the contents of a receptacle derived from an apparatus that scans the receptacle with penetrating radiation. The method also comprises processing the data conveying the image of the contents of the receptacle to derive an area of interest in the image, the area of interest potentially containing a threat. The method also comprises displaying on a display device first threat information conveying the area of interest in the image while processing the area of interest in the image using an automated threat detection processor to derive second threat information associated to the receptacle. The method also comprises displaying on the display device the second threat information, the second threat information being displayed subsequently to the displaying of the first threat information.

Advantageously, the first threat information displayed to the user and conveying an area of interest attracts the screener's attention to a certain area of the image so that the screener can perform a visual examination of that image focusing on this area of interest. While the screener performs such a visual examination, the area of interest is processed using an automated threat detection processor to derive additional threat information, namely the second threat information. The second threat information is then displayed to the user. In this fashion, threat detection information is incrementally provided to the user for facilitating visual identification of a threat in an image.

The second threat information may convey any suitable information for facilitating visual identification of a threat in an image during security screening. In a specific example of implementation, the second threat information conveys a level of confidence that the receptacle contains a threat. Alternatively, the second threat information may convey identification information associated to a prohibited object potentially located in the receptacle. In yet another alternative, the second threat information conveys a perceived threat level associate with the receptacle.

In another specific example of implementation, the method comprises processing the data conveying the image of the contents of the receptacle to derive a plurality of areas of interest in the image, each area of interest potentially containing a threat. The method also comprises displaying on the display device first threat information conveying the plurality of areas of interest in the image. The areas of interest in the image may be sequentially processed or may be processed in parallel to derive second threat information.

In a specific example of implementation, the method comprises processing the image at least in part based on the area of interest in the image to generate an enhanced image in which portions outside the area of interest are visually de-emphasized and displaying the enhanced image.

In accordance with another broad aspect, the invention provides and apparatus suitable for implementing a user interface for facilitating visual identification of a threat in an image during security screening in accordance with the above described method.

In accordance with another broad aspect, the invention provides a computer readable storage medium including a program element suitable for execution by a CPU for implementing a graphical user interface module for facilitating visual identification of a threat in the image during security screening in accordance with the above described method.

In accordance with yet another broad aspect, the invention provides a system for facilitating detection of a threat in a receptacle. The system comprises an image generation apparatus, a display device and an apparatus for facilitating visual identification of a threat in an image during security screening. The image generation apparatus is suitable for scanning a receptacle with penetrating radiation to generate data conveying an image of contents of the receptacle. The apparatus for facilitating visual identification of a threat in an image is in communication with the image generation apparatus and with the display device. This apparatus comprises an input for receiving data conveying an image of the contents of a receptacle derived from the image generation apparatus. The apparatus also comprises a processing unit in communication with the input and operative for processing the data conveying the image of the contents of the receptacle to derive an area of interest in the image, the area of interest potentially containing a threat. The processing unit is also operative for displaying on the display device first threat information conveying the area of interest in the image while processing the area of interest in the image to derive second threat information associated to the receptacle. The processing unit is also operative for displaying on the display device the second threat information, the second threat information being displayed subsequently to the displaying of the first threat information.

In accordance with yet another broad aspect, the invention provides a client-server system for implementing a graphical user interface module for facilitating visual identification of a threat in an image during security screening. The client-server system comprises a client system and a server system operative to exchange messages over a data network. The server system stores a program element for execution by a CPU. The program element comprises a first program element component executed on the server system for receiving data conveying an image of the contents of a receptacle derived from an apparatus that scans the receptacle with penetrating radiation. The program element also comprises a second program element component executed on the server system for processing the data conveying the image of the contents of the receptacle to derive an area of interest in the image, the area of interest potentially containing a threat. The program element also comprises a third program element component executed on the server system for sending a message to the client system for causing a display device associated with the client system to display first threat information conveying the area of interest in the image. The program element also comprises a fourth program element component executed on the server system for processing the area of interest in the image to derive second threat information associated to the receptacle. The program element also comprises a fifth program element component executed on the server system for sending a message to the client system for causing a display device associated with the client system to display the second threat information. The second threat information is caused to be displayed subsequently to the displaying of the first threat information.

In accordance with yet another broad aspect, the invention provides an apparatus for facilitating visual identification of a threat in an image during security screening. The apparatus comprises means for receiving data conveying an image of the contents of a receptacle derived from an apparatus that scans the receptacle with penetrating radiation. The apparatus also comprises means for processing the data conveying the image of the contents of the receptacle to derive an area of interest in the image, the area of interest potentially containing a threat. The apparatus also comprises means for displaying on a display device first threat information conveying the area of interest in the image while processing the area of interest in the image to derive second threat information associated to the receptacle. The apparatus also comprises means for displaying on a display device the second threat information, the second threat information being displayed subsequently to the displaying of the first threat information.

In accordance with yet another broad aspect, the invention provides a method for facilitating visual identification of a threat in an image during security screening. The method comprises receiving data conveying an image of the contents of a receptacle derived from an apparatus that scans the receptacle with penetrating radiation. The method also comprises processing the data conveying the image of the contents of the receptacle to derive a sequence of information elements conveying threat information associated to the receptacle. The sequence of information elements conveys at least first threat information and second threat information. The method also comprises incrementally displaying on a display device threat information associated to the receptacle at least in part based on the sequence of information elements. The incrementally displaying being effected such that the first threat information is displayed on the display device while the second threat information is being derived.

Advantageously, threat detection information is provided to the user for facilitating visual identification of a threat in an image while additional threat information is being derived.

Other aspects and features of the present invention will become apparent to those ordinarily skilled in the art upon review of the following description of specific embodiments of the invention in conjunction with the accompanying Figures.

### BRIEF DESCRIPTION OF THE DRAWINGS

A detailed description of the embodiments of the present invention is provided herein below, by way of example only, with reference to the accompanying drawings, in which:

FIG. 1 is a high-level block diagram of a system for facilitating detection of a threat in a receptacle in accordance with a specific example of implementation of the present invention;

FIG. 2 is a block diagram of an apparatus for facilitating visual identification of a threat suitable for use in connection with the system depicted in FIG. 1 in accordance with a specific example of implementation of the present invention;

FIG. 3 is a block diagram of a display control module suitable for use in connection with the apparatus depicted in FIG. 2 in accordance with a specific example of implementation of the present invention;

FIG. 4 shows a flow diagram depicting a process implemented by the display control module shown in FIG. 3 in accordance with a specific example of implementation of the present invention;

FIGS. 5a, 5b and 5c depict a viewing window of a user interface displayed by the display control module of FIG. 3 at different times (T₁, T₂ and T₃) in accordance with a specific example of implementation of the present invention;

FIG. 6 depicts a control window of a user interface module displayed by the display control module of FIG. 3 for allowing a user to configure screening options in accordance with a specific example of implementation of the present invention;

FIG. 7 is a flow diagram depicting a process for facilitating visual identification of threats in images associated with previously screened receptacles in accordance with a specific example of implementation of the present invention;

FIG. 8 is a block diagram of an automated threat detection processor suitable for use in connection with the apparatus depicted in FIG. 2 in accordance with a specific example of implementation of the present invention;

FIGS. 9a and 9b are flow diagrams of a process suitable to be implemented by the automated threat detection processor depicted in FIG. 8 in accordance with a specific example of implementation of the present invention;

FIG. 10 is a block diagram of an apparatus suitable for implementing either one or both the automated threat detection processor depicted in FIG. 8 and the display control module shown in FIG. 3 in accordance with a specific example of implementation of the present invention;

FIG. 11 is a block diagram of an apparatus suitable for implementing either one or both the automated threat detection processor depicted in FIG. 8 and the display control module shown in FIG. 3 in accordance with an alternative specific example of implementation of the present invention;

FIG. 12 shows a functional block diagram of a client-server system suitable for implementing a system for facilitating visual identification of a threat in an image during security screening in accordance with an alternative specific example of implementation of the present invention;

FIGS. 13a and 13b depict a first example of an original image conveying contents of a receptacle and a corresponding enhanced image in accordance with a specific example of implementation of the present invention;

FIGS. 13c and 13d depict a second example of an original image conveying contents of a receptacle and a corresponding enhanced image in accordance with a specific example of implementation of the present invention;

FIGS. 13e, 13f and 13g depict a third example of an original image conveying contents of a receptacle and two (2) corresponding enhanced images in accordance with a specific example of implementation of the present invention;

FIG. 14 is a graphical illustration of a process implemented by the automated threat detection processor depicted in FIG. 8 in accordance with an alternative specific example of implementation of the present invention;

FIG. 15 a graphical representation of an entry in a database of images suitable for use in connection with the apparatus depicted in FIG. 2 in accordance with a specific example of implementation of the present invention.

In the drawings, the embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION

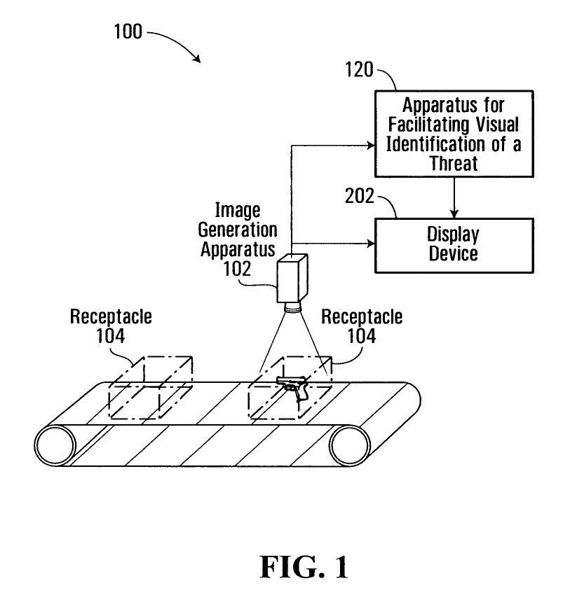

Shown in FIG. 1 is a system 100 for screening receptacles and for facilitating detection of a threat therein in accordance with a specific example of implementation of the present invention. It is to be understood that the expression “receptacle”, as used for the purposes of the present description, is used to broadly describe an entity adapted for receiving objects therein such as, for example, a luggage item, a cargo container or a mail parcel. In addition, the expression “luggage item” is used to broadly describe luggage, suitcases, handbags, backpacks, briefcases, boxes, parcels or any other similar type of item suitable for containing objects therein.

As depicted, the system 100 includes an image generation apparatus 102, an apparatus 120 for facilitating visual identification of a threat in an image in communication with the image generation apparatus 102 and a display device 202.

The image generation apparatus 102 is adapted for scanning a receptacle 104 to generate data conveying an image of contents of the receptacle 104. The apparatus 120 receives the data conveying the image of contents of the receptacle 104 and processes that image to derive an area of interest in the image, the area of interest potentially containing a threat. The apparatus 120 displays in the display device 202 first threat information conveying the area of interest in the image while processing the area of interest in the image to derive second threat information associated to the receptacle. The apparatus 120 also displays on the display device 202 the derived second threat information. Since the first threat information conveying the area of interest in the image is displayed while the second threat information is being derived, the second threat information is displayed subsequently to the displaying of the first threat information.

In a specific example of implementation, the screening system 100 makes use of multiple processing operations in order to provide information to a screening operator for facilitating visual identification of potential threats in receptacle. More specifically, the system operates by first making use of information intrinsic to the X-ray image to identify one or more areas of interest in the image. Since this information is not dependent upon the size of a database to be consulted, the information is typically generated relatively quickly and is then displayed to the user on display device. The system then makes use of the located areas of interest to perform in-depth image-processing. In a specific example of implementation, the image processing makes use of a reference database to locate pre-determined types of objects or pre-determined shapes in the areas of interest. Once the image processing has been completed, this subsequent information can then be displayed to the user.

One of the advantages is that this system 100 provides interim results to the user, these interim results being suitable for guiding the screener in visually identifying potential threats. More specifically, the first threat information displayed to the user and conveying an area of interest attracts the screener's attention to a certain area of the image so that the screener can perform a visual examination of that image focusing on this area of interest. While the screener performs such a visual examination, the area of interest is processed using an automated threat detection processor to derive additional threat information, namely the second threat information. The second threat information is then displayed to the user. In this fashion, threat detection information is incrementally provided to the user for facilitating visual identification of a threat in an image. By providing interim results to the user, in the form of first threat information conveying an area of interest, prior to the completion of the processing to derive the second threat information, the responsiveness of the system 100 as perceived by a user of the system is increased.

Examples of the manner in which the information indicating an area of interest in the image and the second threat information associated to the receptacle 104 can be derived will be described later on in the specification.

Image Generation Apparatus 102

In a specific example of implementation, the image generation apparatus 102 uses penetrating radiation or emitted radiation to generate data conveying an image of the contents of the receptacle 104. Specific examples of such devices include, without being limited to, x-ray, gamma ray, computed tomography (CT scans), thermal imaging, TeraHertz and millimeter wave devices. Such devices are known in the art and as such will not be described further here. In a non-limiting example of implementation, the image generation apparatus 102 is a conventional x-ray machine suitable for generating data conveying an x-ray image of the receptacle 104. The x-ray image conveys, amongst others, material density information in relation to objects within the receptacle. The data generated by the image generation apparatus 102 and conveying an image of the contents of the receptacle 104 may convey as a two-dimensional (2-D) image or a three-dimensional (3-D) image and may be in any suitable format. Possible formats include, without being limited to, JPEG, GIF, TIFF and bitmap amongst others.

Display Device 202

The display device 202 may be any device suitable for conveying information in visual format a user of the system 100. In a specific example of implementation, the display device 202 is in communication with the apparatus 120 and includes a display screen adapted for displaying in visual format information related to the presence of a threat in the receptacle 104. The display device 202 may be part of a stationary computing station or may be integrated into a hand-held portable device for example. In addition the display device 202 may be in communication with the apparatus 120 over any suitable type of communication link include a wire-line link and a wireless link.

In another specific example of implementation, the display device 202 includes a printer adapted for displaying information in printed format.

The person skilled in the art will readily appreciate, in light of the present specification, that other suitable types of display devices may be used here without detracting from the spirit of the invention.

Apparatus 120

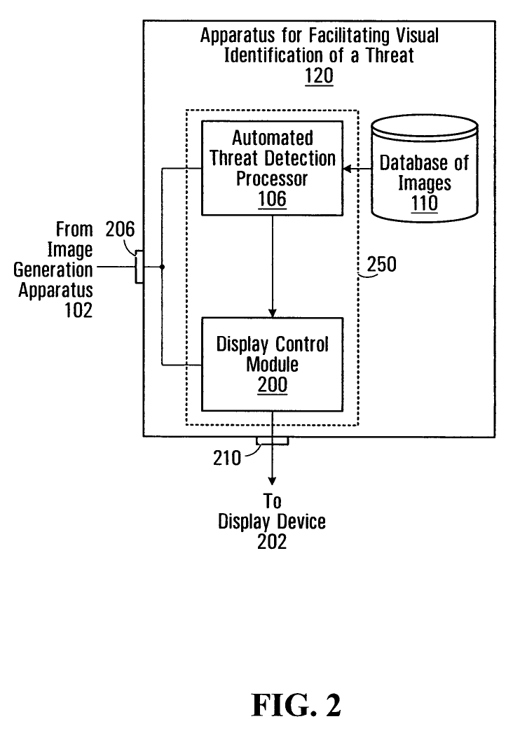

The apparatus 120 for facilitating visual identification of a threat in an image will now be described in greater detail with reference to FIG. 2 of the drawings.

As depicted, the apparatus 120 includes an input 206, an output 210 and a processing unit 250 in communication with the input 206 and the output 210.

The input 206 is for receiving data conveying an image of the contents of a receptacle derived from the image generation apparatus 102 (shown in FIG. 1).

The output 210 is for releasing signals for causing display device 202 (shown in FIG. 1) to display information to a user for facilitating visual identification of a threat in the image of the contents of a receptacle conveyed by the data received at input 206.

The processing unit 250 is operative for releasing a signal at the output 210 for causing the display device 202 (shown in FIG. 1) to display first threat information conveying the area of interest in the image. While the first threat information is being displayed, the processing unit 250 processes the area of interest in the image to derive second threat information associated to the receptacle. Once the second information is derived, the processing unit 250 is operative for releasing a signal at the output 210 for causing the display device 202 (shown in FIG. 1) to display the second threat information. In this fashion, the second threat information is displayed subsequently to the first threat information.

In the specific example of implementation depicted in FIG. 2, the processing unit 250 includes an automated threat detection processor 106 and a display control module 200 in communication with the automated threat detection processor 106.

The automated threat detection processor 106 is in communication with the image generation apparatus 102 (shown in FIG. 1) through input 206. The automated threat detection processor 106 receives the data conveying an image of contents of the receptacle 104 (also shown in FIG. 1) and processes that data to derive one or more areas of interest in the image. The automated threat detection processor 106 then releases to the display control module 200 data conveying the one or more areas of interest in the image. The automated threat detection processor 106 also processes the area of interest in the image to derive second threat information associated to the receptacle 104. The second threat information may convey any suitable information for facilitating visual identification of a threat in an image during security screening. In a specific example of implementation, the second threat information conveys a level of confidence that the receptacle 104 (shown in FIG. 1) contains a threat. Alternatively, the second threat information may convey identification information associated to a prohibited object potentially located in the receptacle 104. In yet another alternative, the second threat information conveys a perceived threat level associated with the receptacle 104. In yet another alternative, the second threat information may convey a combination of information elements including subsets of the above described examples or other suitable information for facilitating visual identification of a threat in an image during security screening. The automated threat detection processor 106 then releases to the display control module 200 the second threat information. The manner in which automated threat detection processor 106 may be implemented will be described later on in the specification.

Display Control Module 200

In a specific example of implementation, the display control module 200 of the apparatus 120 implements a user interface module for conveying information to a user through the display device 202 (shown in FIG. 1) for facilitating visual identification of a threat in an image of receptacle 104 (shown in FIG. 1). The display control module 200 receives the data conveying the one or more areas of interest in the image potentially containing a threat and released by the automated threat detection processor 106. The display control module 200 also receives data conveying an image of the contents of a receptacle derived from the image generation apparatus 102 (shown in FIG. 1). The display control module 200 then generates a signal for causing first threat information conveying the area of interest in the image to be displayed on display device 202 (shown in FIG. 1). The signal generated is released at output 210. The display control module 200 also receives the second threat information released by the automated threat detection processor 106. The display control module 200 then generates a signal for causing the second threat information to be displayed in the display device 202 (shown in FIG. 1).

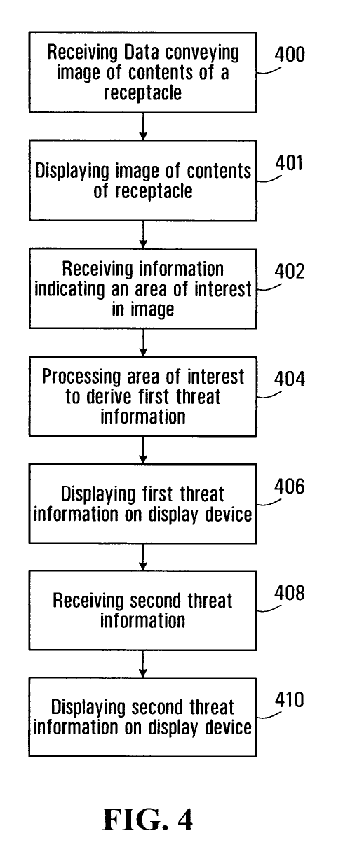

A specific example of a method implemented by the display control module 200 will now be described with reference to FIG. 4. At step 400, data is received conveying an image of the contents of a receptacle derived from an apparatus that scans the receptacle with penetrating radiation such as the image generation apparatus 102 depicted in FIG. 1.

At step 401, the display control module 200 displays on the display device 202 (shown in FIG. 1) the image of the contents of a receptacle based on the data received at step 400.

At step 402, information is received from the automated threat detection processor 106 conveying an area of interest in the image potentially containing a threat.

In a specific example of implementation, the information received from the automated threat detection processor 106 at step 402 includes location information conveying a location in the image of the contents of a receptacle derived from the image generation apparatus 102 (shown in FIG. 1).

In a first non-limiting example of implementation, the location information is an (X,Y) pixel location conveying the center of an area in the image. The area of interest is established based on the center location (X,Y) provided by the automated threat detection processor 106 in combination with a shape for the area. The shape of the area may be pre-determined in which case it may be of any suitable geometric shape and will have any suitable size. Alternatively, the shape and/or size of the area of interest may be determined by the user on the basis of a user configuration command.

In a second non-limiting example of implementation, the shape and/or size of the area of interest is determined on the basis of information provided by the automated threat detection processor 106. For example, the information may convey a plurality of (X,Y) pixel locations defining an area in the image of the contents of a receptacle. In such a case, the information received will convey both the shape of the area of interest in the image and the position of the area of interest in that image.

In yet another non-limiting example of implementation, the automated threat detection processor 106 may provide an indication of a type of prohibited object potentially identified in the receptacle being screened in addition to a location of that potentially prohibited object in the image. Based on this potentially identified prohibited object, an area of interest having a shape and size conditioned on the basis of the potentially identified prohibited object may be determined.

At step 404, the information conveying an area of interest in the image received at step 402 is processed to derive first threat information conveying the area of interest in the image received at step 400. In a first specific example of implementation, the first threat information is in the form of an enhanced image of the contents of a receptacle. The enhanced image conveys the area of interest in a visually contrasting manner relative to portions of the image outside the area of interest. The enhanced image is such that portions outside the area of interest are visually de-emphasized or in which features appearing inside the area of interest are visually emphasized. Alternatively, the enhanced image is such that portions outside the area of interest are visually de-emphasized and in which features appearing inside the area of interest are visually emphasized. Many different methods for visually emphasizing the area of interest in the image received at step 400 may be used in accordance with the spirit of the invention. Examples of such methods include, without being limited to, highlighting the area of interest, overlaying a graphical representation of a boundary surrounding the area of interest and applying image manipulation methods for emphasizing features appearing inside the area of interest and/or de-emphasizing features appearing outside the area of interest. Hence in a specific example of implementation, at step 404, the image received at step 400 is processed based on the information received at step 402 to generate first threat information in the form of an enhanced image. It will be appreciated that, although the above described example has described first threat information as being an enhanced image, alternative implementations of the invention may derive others forms of first threat information conveying the area of interest in the image without detracting from its spirit. For example, the first threat information may be in the form of an arrow or other graphical symbol displayed in combination with the image received at step 400 and conveying the location of the area of interest.

At step 406, the display control module 200 displays on the display device 202 (shown in FIG. 1) the first threat information derived at step 404.

At step 408, second threat information conveying threat information associated with the receptacle being screened is received from the automated threat detection processor 106. The second threat information may convey any useful information suitable for facilitating visual identification of a threat in an image during security screening. Specific examples of such second threat information include, without being limited to, a level of confidence that the receptacle 104 (shown in FIG. 1) contains a threat, identification information associated to a prohibited object potentially located in the receptacle 104 and a perceived threat level associate with the receptacle 104.

At step 410, the display control module 200 displays on the display device 202 (shown in FIG. 1) information derived from the second threat information received at step 408.

It will be appreciated to the person skilled in the art that, in alternative example of implementations not shown in the figures, additional threat information may be received by the display control module 200 subsequently to the second threat information received at step 408. As such, in certain examples of implementation, step 408 and 410 may be repeated for each additional threat information received by the display control module 200 from the automated threat detection processor 106.

It will be appreciated to the person skilled in the art that, in alternative example of implementations not shown in the figures, that second threat information may be received for each region of interest received at step 402. As such, in certain examples of implementation, step 408 and 410 may be repeated for each region of interest received from the automated threat detection processor 106.

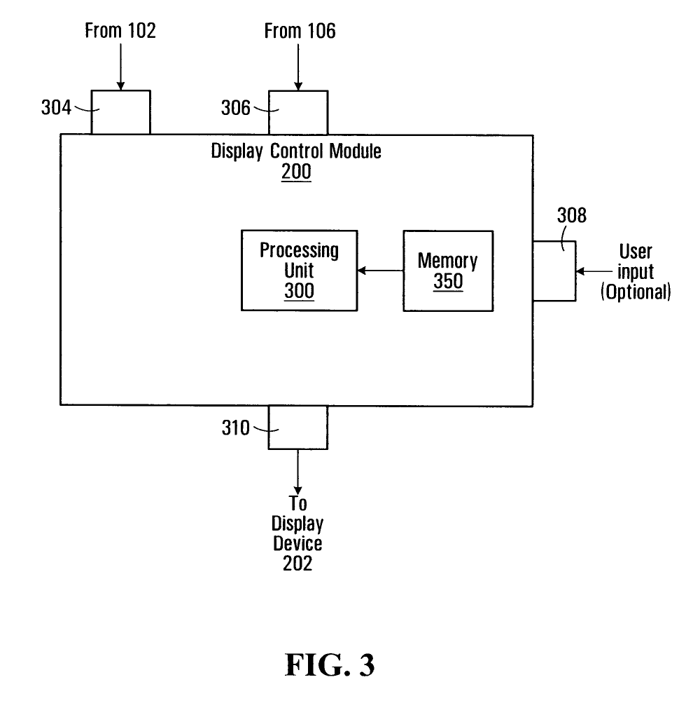

A functional block diagram of the display control module 200 is depicted in FIG. 3 of the drawings. As depicted, the display control module 200 implementing the above described process includes a first input 304, a second input 306, a processing unit 300 and an output 310. Optionally, as depicted in FIG. 3, the display control module 200 further includes a user input 308.

The first input 304 is for receiving data conveying an image of the contents of a receptacle derived from an apparatus that scans the receptacle with penetrating radiation. In a specific implementation, the image signal is derived from a signal generated by the image generation apparatus 102 (shown in FIG. 1).

The second input 306 is for receiving information from an automated threat detection processor indicating an area of interest in the image potentially containing a threat and additional threat information associated to the receptacle being screened. In a specific implementation, the information is provided by the automated threat detection processor 106 (shown in FIG. 2). The type of information received at the second input 306 depends on the specific implementation of the automated threat detection processor 106 and may vary from one implementation to the next without detracting from the spirit of the invention. Examples of the type of information that may be received include information on the position of the threat detected within the image, information about the level of confidence of the detection and data allowing identifying a certain prohibited object potentially detected.

The user input 308, which is an optional feature, is for receiving signals from a user input device, the signals conveying commands for controlling the type information displayed by the user interface module or for annotating the information displayed. Any suitable user input device for providing user commands may be used such as, for example, a mouse, keyboard, pointing device, speech recognition unit or touch sensitive screen.

The processing unit 300 is in communication with the first input 304, the second input 306 and the user input 308 and implements a user interface module for facilitating visual identification of a threat in an image of contents of a receptacle. More specifically, the processing unit 300 is adapted for implementing the process described in connection with FIG. 4 and for releasing signals at output 310 for causing display device 202 to display first threat information conveying an area of interest in the image and second threat information.

For the purpose of illustration, a specific example of implementation where the first threat information conveying the area of interest in the image is in the form of an enhanced image of the contents of a receptacle will be described.

In this specific example, the processing unit 300 is operative for processing the image of the receptacle received at the first input 304 to generate an enhanced image based at least in part on the information received at the second input 306 and optionally on commands received at the user input 308. In a specific example of implementation, the processing unit 300 is adapted for generating an image mask on the basis of the information received at the second input 306 indicating an area of interest in the image. The image mask includes a first enhancement area corresponding to the area of interest and a second enhancement area corresponding to portions of the image outside the area of interest.

The image mask allows applying a different type of image enhancement processing to portions of the image corresponding to the first enhancement area and the second enhancement area to generate an enhanced image.

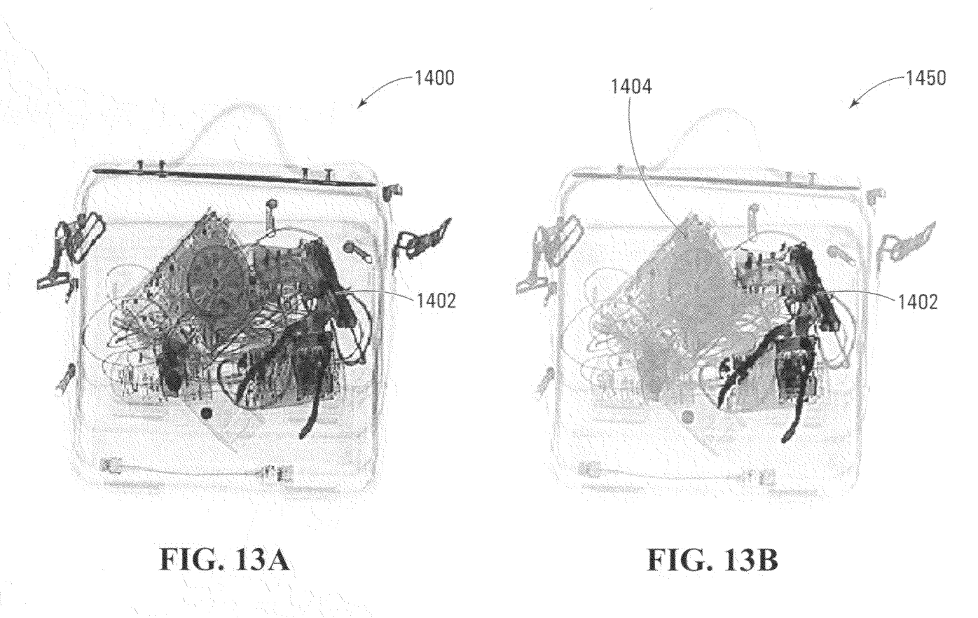

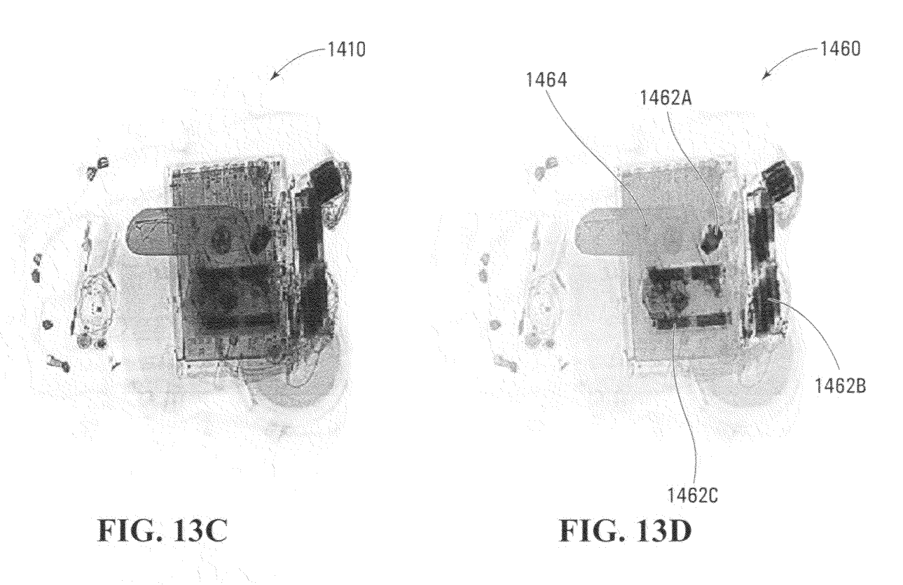

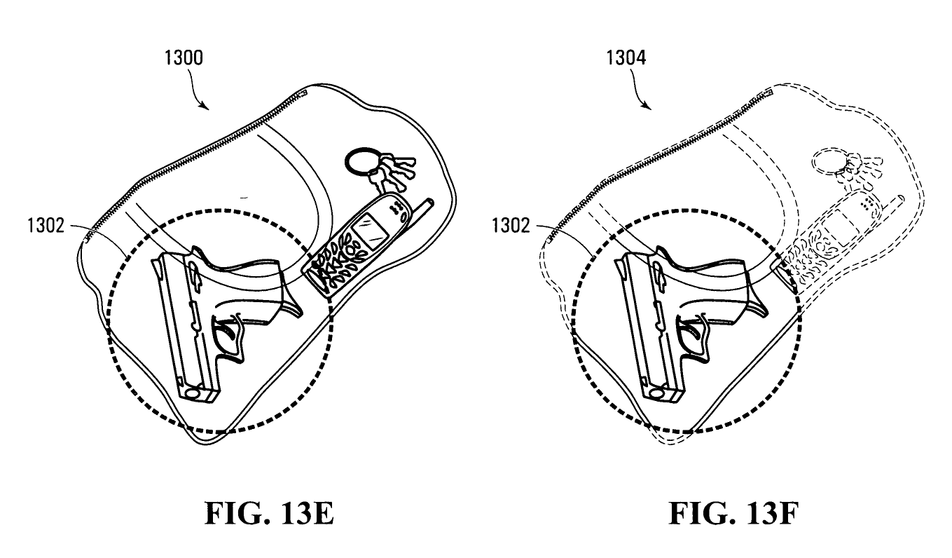

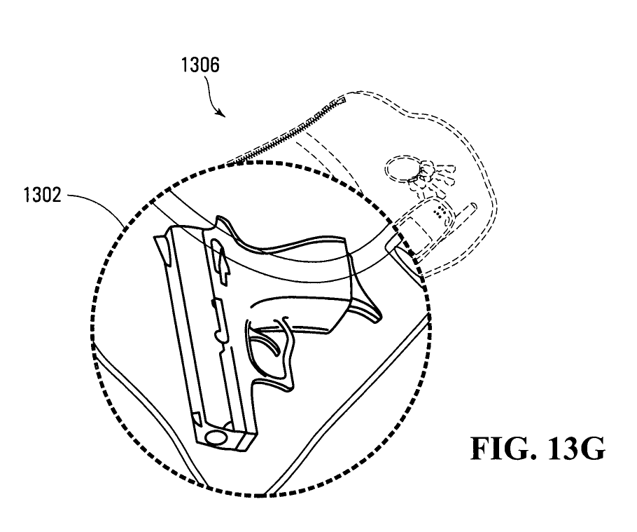

FIGS. 13a to 13g depict various illustrative examples of images and corresponding enhanced images that may be generated by the processing unit 300 (shown in FIG. 3) in accordance with specific examples of implementation of the invention.

FIG. 13a depicts a first exemplary image 1400 conveying contents of a receptacle that was generated by an x-ray machine. The processing unit 300 (shown in FIG. 3) processes the first exemplary image 1400 to derive information conveying an area of interest, denoted as area of interest 1402 in the figure. FIG. 13b depicts an enhanced version of the image of FIG. 13a, herein referred to as enhanced image 1450 resulting from the application of an image mask include an enhanced area corresponding to the area of interest 1402. In the example shown, the enhanced image 1450 is such that portions 1404 of the image which lie outside the area of interest 1402 have been visually de-emphasized and features appearing inside the area of interest 1402 have been visually emphasized.

FIG. 13c depicts a second exemplary image 1410 conveying contents of another receptacle that was generated by an x-ray machine. The processing unit 300 (shown in FIG. 3) processes the second exemplary image 1410 to derive information conveying a plurality of areas of interest, denoted as areas of interest 1462a 1462b and 1462c in the figure. FIG. 13d depicts an enhanced version of the image of FIG. 13c, herein referred to as enhanced image 1460. In the example shown, the enhanced image 1460 is such that portions 1464 of the image which lie outside the areas of interest 1462a 1462b and 1462c have been visually de-emphasized and features appearing inside the areas of interest 1462a 1462b and 1462c have been visually emphasized.

FIG. 13e depicts a third example of an illustrative image 1300 conveying contents of a receptacle. The processing unit 300 (shown in FIG. 3) processes the image 1300 to derive information conveying an area of interest, denoted as area of interest 1302 in the figure. FIG. 13f depicts a first enhanced version of the image of FIG. 13e, herein referred to as enhanced image 1304. In the example shown, the enhanced image 1304 is such that portions of the image which lie outside the area of interest 1302 have been visually de-emphasized. The de-emphasis is illustrated in the figure by the features appearing in portions of the image that lie outside the area of interest being presented in dotted lines. FIG. 13g depicts a second enhanced version of the image of FIG. 13e, herein referred to as enhanced image 1306. In the example shown, the enhanced image 1306 is such that features appearing inside the area of interest 1302 have been visually emphasized. The emphasis is illustrated in the figure by the features appearing in the area of interest being enlarged such that features of the enhanced image 1306 located inside the area of interest 1302 appear on a larger scale than features in portions of the enhanced image located outside the area of interest.

De-Emphasizing Portions or Image Outside the Area of Interest

Returning now to FIG. 3, in a first example of implementation, the processing unit 300 processes the image received at input 304 to generate an enhanced image wherein portions outside the area of interest, conveyed by the information received at second input 306, are visually de-emphasized. Any suitable image manipulation technique for de-emphasizing the visual appearance of portions of the image outside the area of interest may be used by the processing unit 300. Such image manipulation techniques are well-known in the art and as such will not be described in detail here.

In a specific example, the processing unit 300 processes the image received at input 304 to attenuate portions of the image outside the area of interest. In a non-limiting example, the processing unit 300 processes the image to reduce contrasts between feature information appearing in portions of the image outside the area of interest and background information appearing in portions of the image outside the area of interest. Alternatively, the processing unit 300 processes the image to remove features from portions of the image outside the area of interest. In yet another alternative embodiment, the processing unit 300 processes the image to remove all features appearing in portions of the image outside the area of interest such that only features in the areas of interest remain in the enhanced image.

In another example, the processing unit 300 processes the image to overlay or replace portions of the image outside the area of interest with a pre-determined visual pattern. The pre-determined visual pattern may be a suitable textured pattern of may be a uniform pattern. The uniform pattern may be a uniform color or other uniform pattern.

In yet another example, where the image includes color information, the processing unit 300 processes the image to modify color information associated to features of the image appearing outside the area of interest. In a non-limiting example of implementation, portions of the image outside the area of interest are converted into grayscale or other monochromatic color palette.

In yet another example of implementation, the processing unit 300 processes the image to reduce the resolution associated to portions of the image outside the area of interest. This type of image manipulation results in portions of the enhanced image outside the area of interest appearing blurred compared to portions of the image inside the area of interest.

In yet another example of implementation, the processing unit 300 processes the image to shrink portions of the image outside the area of interest such that at least some features of the enhanced image located inside the area of interest appear on a larger scale than features in portions of the enhanced image located outside the area of interest.

It will be appreciated that the above-described techniques for de-emphasizing the visual appearance of portions of the image outside the area of interest may be used individually or in combination with one another. It will also be appreciated that the above described exemplary techniques for de-emphasizing the visual appearance of portions of the image outside the area of interest are not meant as an exhaustive list of such techniques and that other suitable techniques may be used without detracting from the spirit of the invention.

Emphasizing Features Appearing Inside the Area of Interest

In a second example of implementation, the processing unit 300 processes the image received at input 304 to generate an enhanced image wherein features appearing inside the area of interest, conveyed by the information received at step 402 (shown in FIG. 4), are visually emphasized. Any image manipulation suitable technique for emphasizing the visual appearance of features of the image inside the area of interest may be used. Such image manipulation techniques are well-known in the art and as such will not be described in detail here.

In a specific example, the processing unit 300 processes the image to increase contrasts between feature information appearing in portions of the image inside the area of interest and background information appearing in portions of the image inside the area of interest. For example, contour lines defining objects inside the area of interest are made to appear darker and/or thicker compared to contour lines in the background. In a non-limiting example, contrast-stretching tools with settings highlighting the metallic content of portions of the image inside the area of interest are used to enhance the appearance of such features.

In another specific example, the processing unit 300 processes the image to overlay portions of the image inside the area of interest with a pre-determined visual pattern. The pre-determined visual pattern may be a suitable textured pattern of may be a uniform pattern. The uniform pattern may be a uniform color or other uniform pattern. In a non-limiting example, portions of the image inside the area of interest are highlighted by overlaying the area of interest with a brightly colored pattern. Preferably the visual pattern has transparent properties in that a user can see features of the image in portions of the image inside the area through the visual pattern once the pattern is overlaid on the image.

In another non-limiting example, the processing unit 300 processes the image to modify color information associated to features of the image appearing inside the area of interest. For example, colors for features of the image appearing inside the area of interest may be made to appear brighter or may be replaced by other more visually contrasting colors. In particular, color associated to metallic objects in an x-ray image may be made to appear more prominently by either replacing it with a different color or changing an intensity of the color. For example, the processing unit 300 may transform features appearing in blue inside the area of interest such that these same features appear in red in the enhanced image.

In another non-limiting example, processing unit 300 processes the image to enlarge a portion of the image inside the area of interest such that at least some features of the enhanced image located inside the area of interest appear on a larger scale than features in portions of the enhanced image located outside the area of interest. FIG. 13g of the drawings, previously described, depicts an enhanced image derived from the image depicted in FIG. 13e wherein the area of interest 1302 has been enlarged relative to the portions of the image outside the area of interest. The resulting enhanced image 1306 is such that the features inside the area of interest 1302 appear on a different scale that the features appearing in the portions of the image outside the area of interest 1302.

It will be appreciated that the above described techniques for emphasizing the visual appearance of portions of the image inside the area of interest may be used individually or in combination with one another or with other suitable techniques without detracting from the spirit of the invention. For example, processing the image may include modifying color information associated to features of the image appearing inside the area of interest and enlarging a portion of the image inside the area of interest. It will also be appreciated that the above described exemplary techniques for emphasizing portions of the image inside the area of interest are not meant as an exhaustive list of such techniques and that other suitable techniques may be used without detracting from the spirit of the invention.

Concurrently De-Emphasizing Portions Outside the Area of Interest Emphasizing Features Inside the Area of Interest

In addition, it will be appreciated that embodiments of the invention may also concurrently de-emphasize portions of the image outside the area of interest and emphasize features of the image inside the area of interest without detracting from the spirit of the invention.

Portions Surrounding the Area of Interest

Optionally, the processing unit 300 processes the image received at input 304 to modify portions of areas surrounding the area of interest to generate the enhanced image. In a specific example, the processing unit 300 modifies portions of areas surrounding the area of interest includes applying a blurring function to the edges surrounding the area of interest. In a specific example of implementation, the edges of the area of interest are blurred. Advantageously, blurring the edges of the area of interest accentuates the contrast between the area of interest and the portions of the image outside the area of interest.

Multiple Areas of Interest

It will be appreciated that, although the above described examples describe situations in which a single area of interest is conveyed by the information received by the display control module 200 from the automated threat detection processor 106 (shown in FIG. 1), implementations of the invention adapted for processing information indicating a plurality of areas of interest in the image are within the scope of the invention. As such, the processing unit 300 is adapted for receiving at input 306 information from an automated threat detection processor, such as automated threat detection processor 106, indicating a plurality of areas of interest in the image potentially containing respective threats. The processing unit 300 then processes the image received at input 304 to generate the enhanced image. The processing of the image is performed using the same principles as those described above with reference to information conveying a single area of interest. The person skilled in the art will readily appreciate, in light of the present description, the manner in which the processing unit 300 may be adapted for processing information conveying a plurality of areas of interest without required further guidance.

Graphical User Interface Module Example

The graphical user interface module implemented by the display control module 200 shown in FIG. 3 allows incrementally displaying threat information associated to a receptacle during security screening. More specifically, the display control module 200 displays information on the display device 202 (shown in FIG. 1) incrementally as the display control module 200 receives information from the automated threat detection processor 106 (shown in FIG. 2).

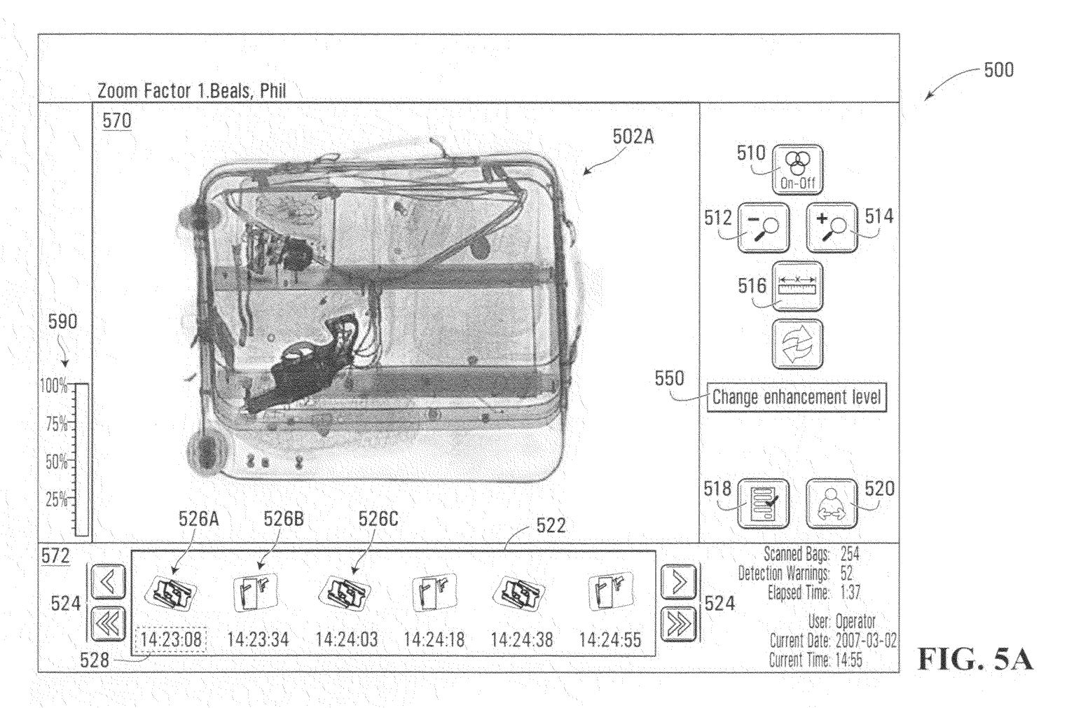

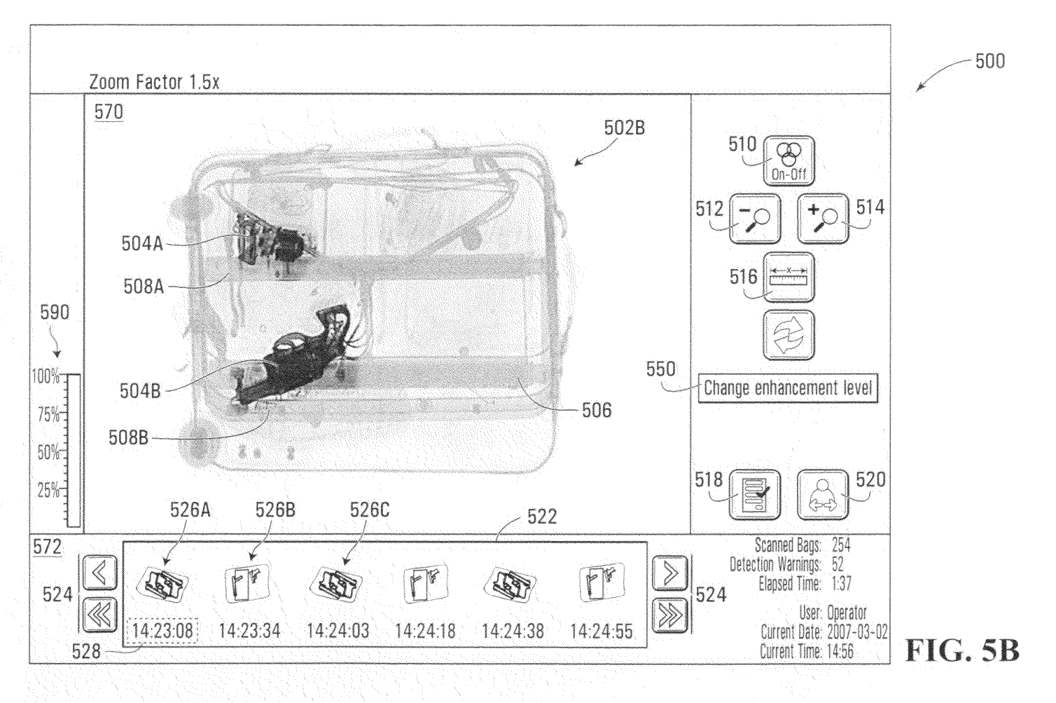

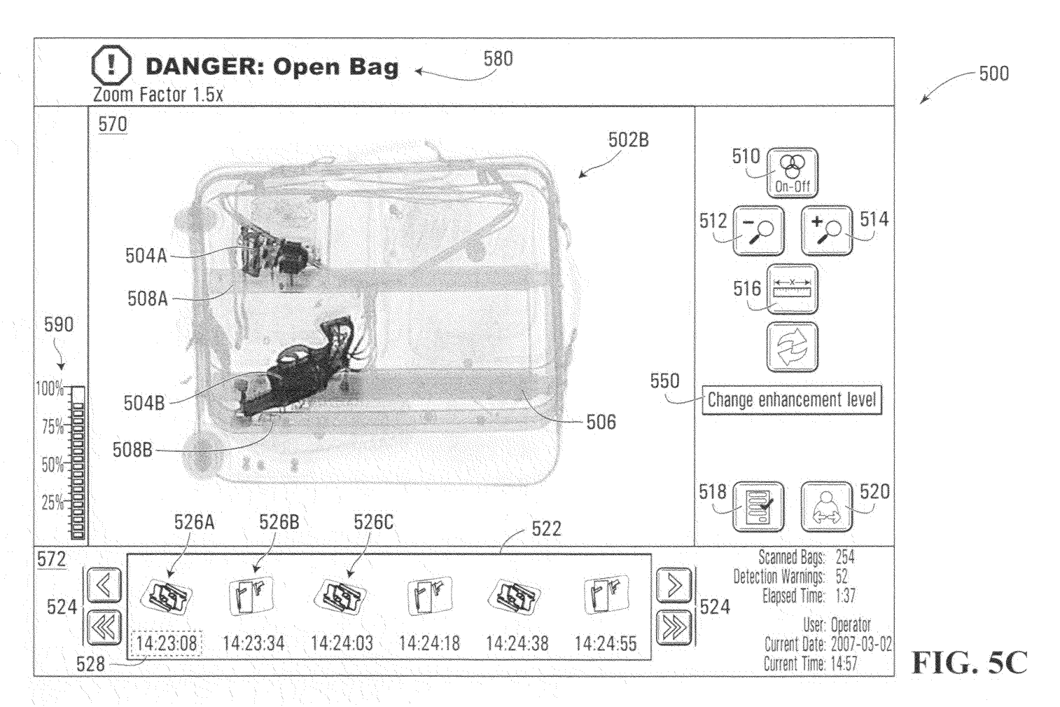

A graphical user interface module implemented by the display control module 200 in accordance with a specific example of implementation will now be described in greater detail herein below with reference to FIGS. 5a, 5b and 5c. FIGS. 5a, 5b and 5c illustrate over time the information displayed to a user of the system 100 (shown in FIG. 1) in accordance with the specific example of implementation of the invention.

More specifically, at time T₀, data conveying an image of the contents of a receptacle 104 originating from the image generation apparatus 102 (shown in FIG. 1) is received at input 304 (shows in FIG. 3). At time T₀, the image displayed on display device 202 may be an image of a previously screened receptacle or, alternatively at time T₀ there may no image displayed to the user.

At time T₁, where T₁ is later than T₀, an image showing the contents of the receptacle 104 is displayed on display device 202. FIG. 5a shows a representation of the graphical user interface module at a time T₁. As depicted, the user interface module provides a viewing window 500 including a viewing space 570 for displaying information to the user. The image 502a displayed at time T₁ conveys the image derived by generation apparatus 102 which was received at input 304 (shows in FIG. 3) at time T₀. While the graphical user interface module displays the image 502a, the automated threat detection processor 106 (shown in FIG. 2) processes the image of the contents of the receptacle derived by generation apparatus 102 (shown in FIG. 1) to derive an area of interest in the image potentially containing a threat.

At time T₂, where T₂ is later than T₁, first threat information conveying the area of interest in the image is displayed on display device 202. FIG. 5b shows the graphical user interface module at a time T₂. As depicted, viewing space 570 displays first threat information in the form of an enhanced image 502b wherein areas of interest 504a and 504b are displayed to the user in a visually contrasting manner relative to portions of the image 506 which are outside the areas of interest. In this fashion, an operator's attention can be focused on the areas interest 504a and 504b of the image which are the areas most likely to contain prohibited objects or potential threats.

In the example depicted, portions of the image outside the areas of interest 504a and 504b have been de-emphasized. Amongst possible other processing, portions of the image outside the areas of interest 504a and 504b, generally designated with reference numeral 506, have been attenuated by reducing contrasts between the features and the background. These portions appear paler relative to the areas of interest 504a and 504b. In the example depicted, features depicted in the areas of interest 504a and 504b have also been emphasized by using contrast-stretching tools to increase the level of contrast between the features depicted in the areas of interest 504a and 504b and the background. Finally, as depicted in the figure, the edges 508a and 508b surrounding the area of interest 504a and 504b have been blurred to accentuates the contrast between the areas of interest 504a and 504b and the portions of the image outside the areas of interest 504a and 504b. The location of the areas of interest 504a and 504b was derived on the basis of the information received at input 306 (shown in FIG. 3) from the automated threat detection processor 106 (shown in FIG. 2).

While the graphical user interface module displays the image 502b shown in FIG. 5b, the automated threat detection processor 106 (shown in FIG. 2) processes the area(s) of interest 504A and 504B in the image to derive second threat information associated to the receptacle.

At time T₃, where T₃ is later than T₂, the second threat information is displayed on display device 202. FIG. 5c shows the graphical user interface module at a time T₃ in accordance with a specific example of implementation. As depicted, viewing window 500 displays second threat information in the form of a perceived level of threat associated to a receptacle. In this embodiment, the perceived level of threat associated to a receptacle is conveyed through two elements namely through a graphical threat probability scale 590 conveying a likelihood that a threat was positively detected in the receptacle and through a message 580 conveying threat level and/or handling recommendation. In a specific example, a confidence level data element is received at input 306 of the display control module 200 (shown in FIG. 3) from automated threat detection processor 106 (shown in FIG. 2). The confidence level conveys a likelihood that a threat was positively detected in the receptacle. In the embodiment depicted in FIG. 5c, the graphical threat probability scale 590 conveying a confidence level (or likelihood) that a threat was positively detected in the receptacle includes various graduated levels of threats. In a specific example of implementation, the message displayed 580 is conditioned on the basis of the confidence level received from the automated threat detection processor 106 and on the basis of a threshold sensitivity/confidence level. As will be described below, the threshold sensitivity/confidence level may be a parameter of the user interface configurable by the user or may be a predetermined value. In a specific example, if the confidence level exceeds the threshold sensitivity/confidence level, a warning message of the type: “DANGER: OPEN BAG” or “SEARCH REQUIRED” may be displayed. If the confidence level is below the threshold sensitivity/confidence level, either no message may be displayed or an alternative message of the type “NO THREAT DETECTED—SEARCH AT YOUR DISCRETION” may be displayed. Optionally, the perceived level of threat conveyed to the user may be conditioned on the basis of external actors such as a national emergency status for example. For example, the national emergency status may either lower or raise the threshold sensitivity/confidence level such that a warning message of the type: “DANGER: OPEN BAG” or “SEARCH REQUIRED” may be displayed at a different confidence level depending on the national emergency status. In will be appreciated that other forms of second threat information may be displayed to the user by viewing window 500 without detracting from the spirit of the invention.

Optionally, as shown in FIGS. 5a-c, the user interface module also provides a set of controls 510 512 514 516 550 518 and 520 for allowing a user to provide commands for modifying features of the graphical user interface module to change the appearance of the enhanced image 502b (shown in FIGS. 5b and 5c) displayed in the viewing window 500.

In a specific implementation, the controls in the set of controls 510 512 514 516 550 518 allow the user to change the appearance of the enhanced image displayed in the viewing space 570 by using an input device in communication with the display control module 200 (shown in FIG. 3) through user input 308. In the example depicted, the controls in the set of controls 510 512 514 516 550 518 are in the form of buttons that can be selectively actuated by a user. Examples of user input devices include, without being limited to, a mouse, a keyboard, a pointing device, a speech recognition unit and a touch sensitive screen. In an alternative embodiment, the controls may be provided as physical buttons (or keys) on a keyboard or other input devices that can be selectively actuated by a user. In such an implementation, the physical buttons (or keys) are in communication with the display control module 200 (shown in FIG. 3) through user input 308. Suitable forms of user controls other than buttons may also be used without detracting from the spirit of the invention.

It will be apparent that certain controls in the set of controls 510 512 514 516 550 518 may be omitted from certain implementations and that additional controls may be included in alternative implementations of user interfaces without detracting from the spirit of the invention.

In the specific example of implementation depicted, functionality is provided to the user for allowing the latter to select for display in viewing space 570 the “original” image 502a (shown in FIG. 5a) or the enhanced image 502b (shown in FIGS. 5b-c). In a specific example, such functionality is enabled by displaying a control on the user interface allowing a user to effect the selection. In FIGS. 5a-c this control is embodied as control button 510 which may be actuated by the user via a user input device to toggle between the enhanced image 502b and the “original” image 502a for display in viewing space 570. Other manners for providing such functionality will become readily apparent to the person skilled in the art in light of the present description and as such will not be described further here.

In the specific example of implementation depicted, functionality is also provided to the user for allowing the latter to select a level of enlargement from a set of possible levels of enlargement to be applied to the image in order to derive the enhanced image for display in the viewing space 570. The functionality allows the user to independently control the scale of features appearing in areas of interest 504a and 504b relative to the scale of features in portions of the image outside the areas of interest 504a and 504b. In a specific example, such functionality may be enabled by displaying a control on the user interface allowing a user to effect the selection of the level of enlargement. In FIGS. 5a-c, this control is embodied as control buttons 512 and 514 which may be actuated by the user via a user input device. In the example depicted, by actuating button 514, the enlargement factor (“zoom-in”) to be applied to the areas of interest 504a and 504b by the processing unit 300 (shown in FIG. 3) is increased and by actuating button 512 the enlargement factor (“zoom-out”) to be applied to the areas of interest 504a and 504b (shown in FIGS. 5b and 5c) is decreased. It will be readily apparent to the person skilled in the art that other type of controls for allowing a user to select a level of enlargement from a set of levels of enlargement may be envisaged without detracting from the spirit of the invention. In a specific example of implementation, the set of possible levels of enlargement includes at least two levels of enlargement. In a non-limiting example, one of the levels of enlargement is a “NIL” level wherein features of the portion of the enhanced image inside the area of interest appear on the same scale as features in portions of the enhanced image outside the area of interest. In other examples of implementation, the set of possible levels of enlargement includes two or more distinct levels of enlargement other that the “NIL” level. The enhanced image is such that portions inside the areas of interest are enlarged at least in part based on the selected level of enlargement. It will also be appreciated that although the above refers to a level of “enlargement” to be applied to the areas of interest 504a and 504b (shown in FIGS. 5b and 5c), a corresponding level of “shrinkage” may instead be applied to portions of the image outside the areas of interest 504a and 504b so that in the resulting enhanced image features in the areas of interest appear on a larger scale than portions of the image outside the area of interest. Other manners for providing such functionality will become readily apparent to the person skilled in the art in light of the present description and as such will not be described further here.

In another specific example of implementation, not depicted in the figure, functionality is also provided to the user for allowing the latter to select a zoom level to be applied to derive the enhanced image 502b (shown in FIGS. 5b and 5c) for display in the viewing space 570. This zoom level functionality differs from the level of enlargement functionality described above, which was enabled by buttons 512 and 514, in that the zoom level functionality affects the entire image with a selected zoom level. In other words, modifying the zoom level does not affect the relative scale between the areas of interest and portions of the image outside the area of interest. In a specific example, such functionality may be enabled by displaying a control on the user interface allowing a user to effect the selection of the zoom level. Any suitable type of control for allowing a user to select a zoom level may be envisaged in specific implementations of the user interface module.

In the specific example of implementation depicted, functionality is also provided to the user for allowing the latter to select a level of enhancement from a set of possible levels of enhancement. The functionality allows the user to independently control the type of enhancement to be applied to the original image 502a (shown in FIG. 5a) to generate the enhanced image 502b (shown in FIGS. 5b and 5c) for display in the viewing space 570.

In a specific example of implementation, the set of possible levels of enhancement includes at least two levels of enhancement. In a non-limiting example, one of the levels of enhancement is a “NIL” level wherein the areas of interest are not emphasized and the portions of the images outside the areas of interest are not de-emphasized. In other examples of implementation, the set of possible levels of enlargement includes two or more distinct levels of enhancement other that the “NIL” level. In a specific example of implementation, each level of enhancement in the set of levels of enhancement is adapted for causing an enhanced image to be derived wherein:
portions inside the areas of interest are visually emphasized at least in part based on the selected level of enhancement; or
portions outside the areas of interest are visually de-emphasized at least in part based on the selected level of enhancement; or
portions inside the areas of interest are visually emphasized and portions outside the areas of interest are visually de-emphasized at least in part based on the selected level of enhancement.

For example, the different levels of enhancement may cause the processing unit 300 (shown in FIG. 3) to apply different types of image processing functions or different degrees of image processing such as to modify the appearance of the enhanced image displayed in the viewing space 570. Advantageously, this allows users to adapt the appearance of the enhanced image 502b based on either user preferences or in order to view an image in a different manner to facilitate visual identification of a threat. In a specific example, the above-described functionality may be enabled by providing a control on the user interface allowing a user to effect the selection of the level of enhancement. In FIGS. 5a-c this control is embodied as control button 550, which may be actuated by the user via a user input device. In the example depicted, by actuating button 550 the type of enhancement to be applied by the processing unit 300 (shown in FIG. 3) is modified based on a set of predetermined levels of enhancement. In an alternative implementation, not shown in the figures, a control in the form of a drop-down menu providing a set of possible levels of enhancement is provided. The user is able to select a level of enhancement from the set of levels of enhancement to modify the type of enhancement to be applied by the processing unit 300 (shown in FIG. 3) to generate the enhanced image. It will be readily apparent to the person skilled in the art that other type of controls for allowing a user to select a level of enhancement from a set of levels of enhancement may be envisaged without detracting from the spirit of the invention.

In a specific example of implementation, not shown in the figures, functionality is also provided to the user for allowing the latter to independently control the amount of enhancement to be applied to the area(s) of interest of the images and the amount of enhancement to be applied to portions of the image outside of the area(s) of interest. In a specific example, the above-described functionality may be enabled by providing on a user interface a first user control for enabling the user to select a first selected level of enhancement, and a second user control is provided for allowing a user to select a second level of enhancement. The processing unit generates the enhanced image such that:
portions inside the area of interest are visually emphasized at least in part based on the selected second level of enhancement; and
portions outside the area of interest are visually de-emphasized at least in part based on the selected first level of enhancement.

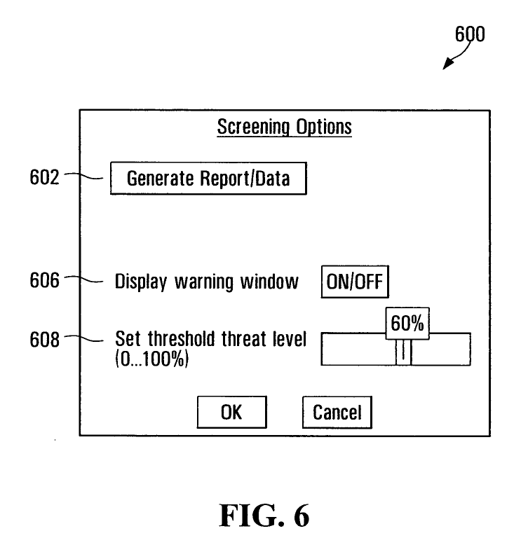

Optionally still, the user interface module is adapted for displaying a control 518 for allowing a user to modify other configuration elements of the user interface. In accordance with a non-liming specific implementation, actuating control 518 causes the user interface module to displays a control window 600 of the type depicted in FIG. 6 allowing a user to select screening options. In the specific example depicted, the user is enabled to select between the following screening options:
Generate report data 602: this option allows a report to be generated detailing information associated to the screening of the receptacle. In the example depicted, this is done by providing a control in the form of a button that can be toggled between an “ON” state and an “OFF” state. It will be readily apparent that other suitable forms of controls may also be used without detracting from the spirit of the invention. The information generated in the report may include, without being limited to, time of the screening, identification of the security personnel operating the screening system, identification of the receptacle and/or receptacle owner (e.g. passport number in the case of a customs screening), locations information, area of interest information, confidence level information, identification of the prohibited object detected and description of the handling that took place and the results of the handling amongst others. Advantageously, this report allows tracking of the screening operation and provides a basis for generating performance metrics of the system 100 (shown in FIG. 1).
Display warning window 606: this option allows a user to cause a visual indicator in the form of a warning window to be removed from or displayed on the user interface module when a threat is detected in a receptacle.
Set threshold sensitivity/confidence level 608: this option allows a user to modify the detection sensitivity level of the screening system. In specific implementations, this may be done by providing a control in the form of a text box, sliding ruler (as shown in FIG. 6), selection menu or other suitable type of control allowing the user to select between a range of detection sensitivity levels. It will be readily apparent that other suitable forms of controls may also be used without detracting from the spirit of the invention.

The person skilled in the art in light of the present description will readily appreciate that other options may be provided to the user and that certain options described above may be omitted from certain implementations without detracting from the spirit of the invention. As a variant, certain options may be selectively provided to certain users or, alternatively, may require a password to be modified. For example, the setting threshold sensitivity/confidence level 608 may only be made available to user having certain privileges (examples screening supervisors or security directors). As such, the user interface module may include some type of user identification functionality, such as a login process, to identify the user of the screening system. Alternatively, the user interface module, upon selection by the user of the setting threshold sensitivity/confidence level 608 option, may prompt the user to enter a password for allowing the user to modify the detection sensitivity level of the screening system.

Optionally still, as shown in FIGS. 5a-c, the user interface module is adapted for displaying a control 520 for allowing a user to login/log-out of the system in order to provide user identification functionality. Manners in which user identification functionality can be provided are well-known in the art and are not critical to the present invention and as such will not be described further here.

Optionally still, not shown in the figures, the user interface module is adapted to allow the user to add complementary information to the information being displayed on the user interface. In a specific example of implementation, the user is enabled to insert markings in the form of text and/or visual indicators in the image displayed in viewing space 570. The marked-up image may then be transmitted to a third party location, such as a checking station, so that the checking station is alerted to verify the marked portion of the receptacle to locate a prohibited object. In such an implementation, the user input 308 (depicted in FIG. 3) receives signals from a user input device, the signals conveying commands for marking the image displayed in the user interface. Any suitable user input device for providing user commands may be used such as, for example, a mouse, keyboard, pointing device, speech recognition unit or touch sensitive screen. The specific manner in which the functionality for marking the image is provided is not critical to the present invention and as such will not be described further here.

Previously Screened Receptacles

With reference to FIG. 3, in accordance with a specific example of implementation, the display control module 200 is adapted for storing information associated with receptacles being screened so that this information may be accessed at a later time. More specifically, for a given receptacle, the display control module 200 is adapted for receiving at first input 304 data conveying an image of the contents of the receptacle. The display control module 200 is also adapted for receiving at second input 306 information from an automated threat detection processor for facilitating the visual identification of a threat in the image receiving at first input 304. The processing unit 300 of display control module 200 is adapted for generating a record associated to the screened receptacle. The record includes the image of the contents of the receptacle received at the first input 304 and optionally the information received at second input 306. In specific examples of implementation, the record for a given screened receptacle may include additional information such as for example a identification of the area(s) of interest in the image, a time stamp, identification data conveying the type of prohibited object potentially detected, the level of confidence of the detection of a threat, a level of risk data element, an identification of the screener, the location of the screening station, identification information associated to the owner of the receptacle and/or any other suitable type of information that may be of interest to a user of the system for later retrieval. The record is then stored in memory 350.

The generation of a record may be effected for all receptacles being screened or for selected receptacles only. In practical implementations of the inventions, in particular in cases with the system 100 (shown in FIG. 1) is used to screen a large number of receptacles, it may be preferred to selectively store the images of the receptacles rather than storing images for all the receptacles. The selection of which images to store may be effected by the user of the user interface by providing a suitable control on the user interface for receiving user command to that effect. Alternatively, the selection of which images may be effected in the basis of information received from the automated threat detection processor 106. For example, a record may be generated for a given receptacle when a threat was potentially detected in the receptacle as could be conveyed by a signal received from the automated threat detection processor 106.

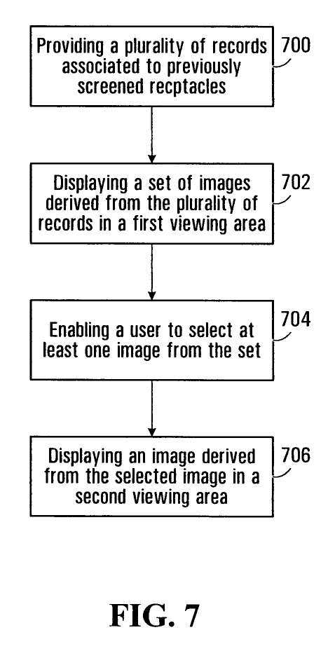

A process for facilitating visual identification of threats in images associated with previously screened receptacles is depicted in FIG. 7 of the drawings.

As shown, at step 700, a plurality of records associated to previously screened receptacles are provided. In a non-limiting example of implementation, with reference to FIG. 3, display control module 200 enables step 700 by providing the memory 350 for storing a plurality of records associated to respective previously screened receptacles. As described above, each record includes an image of the contents of a receptacle derived from an apparatus that scans the receptacle with penetrating radiation and information derived from an automated threat detection processor for facilitating the visual identification of a threat in the corresponding image in the record.

Returning to FIG. 7, at step 702, a set of thumbnail images derived from the plurality of records is displayed. As shown in FIGS. 5a-c, a set of thumbnail images 522 are displayed in viewing space 572, each thumbnail image 526a 526b 526c in the set of thumbnail images 522 being derived from a record in the plurality of records stored in memory unit 350 (shown in FIG. 3).

Returning to FIG. 7, at step 704, a user in enabled to select at least one thumbnail image from the set of thumbnail images. The selection may be effected on the basis of the images themselves or by allowing the user to specify either a time or time period associated to the records. In the specific example depicted in FIGS. 5a-c, the user can select thumbnail image from the set of thumbnail images 522 using a user-input device to actuate the desired thumbnail image. Any suitable user input device for providing user commands may be used such as, for example, a mouse, keyboard, pointing device, speech recognition unit or touch sensitive screen.

Returning to FIG. 7, at step 706, an enhanced image derived from a record corresponding to the selected thumbnail image is displayed in a viewing space on the user interface. More specifically, with reference to FIGS. 5a-c, in response to a selection of a thumbnail image from the set of thumbnail images 522, an enhanced image derived from the certain record corresponding to the selected thumbnail image is displayed in viewing space 570. When multiple thumbnail images are selected, the corresponding enhanced images may be displayed concurrently with another or may be displayed separately in viewing space 570.

The enhanced imaged derived from the certain record corresponding to the selected thumbnail image may be derived in a similar manner as that described previously in the present specification. For example, a given record in the database of records includes a certain image of contents of a receptacle and information conveying a certain area of interest in the certain image. In a first example, portions of the certain image outside the certain area of interest may be visually de-emphasized to generate the enhanced image. In a second example of implementation, features appearing inside the certain area of interest are visually emphasized to generate the enhanced image. In yet another example, the portions of the image outside the certain area of interest are visually de-emphasized and features appearing inside the certain area of interest are visually emphasized to generate the enhanced image. Manners in which the portions of the certain image outside the certain area of interest may be visually de-emphasized and features appearing inside the certain area of interest may visually emphasized have been previously described in the present applicable and as such will not be described further here.

In the specific example of implementation depicted, with reference to FIGS. 5a-c, functionality is also provided to the user for allowing the latter to scroll through a plurality of thumbnail images so the different sets of the thumbnail images may be displayed in viewing space 572. In a specific example, such functionality may be enabled by displaying a control on the user interface allowing a user to scroll through plurality of thumbnail images. In FIGS. 5a-c this control is embodied as scrolling controls 524 which may be actuated by the user via a suitable user input device.

Optionally, each thumbnail image in the set of thumbnail images conveys information derived from an associated time stamp data element. In the example depicted in FIGS. 5a-c, this is done by displaying timing information 528. Optionally, not shown in the figures, each thumbnail image in the set of thumbnail images conveys information derived from a confidence level data element. It will be readily apparent to the person skilled in the art that any suitable additional type of information may be displayed or conveyed in connection with the thumbnail images without detracting from the spirit of the invention.

Optionally, the user interface module implemented by display control module 200 (shown in FIG. 3) includes functionality for enabling a user to select between an enhanced image associated to a previously screened receptacle, herein referred to as enhanced previous image, and an enhanced image associated with a receptacle currently being screened. More specifically, with reference to FIG. 3, data conveying a current image of the contents of a currently screened receptacle derived from an apparatus that scans the currently screened receptacle with penetrating radiation is received at first input 304 of display control module 200. In addition, information from an automated threat detection processor 106 indicating an area of interest in the current image potentially containing a prohibited object is received at second input 306 of display control module 200. The processing unit 300 is adapted for processing the current image to generate first information in the form of an enhanced current image. The user interface module enables the user to select between an enhanced previous image and the enhanced current image by providing a user operable control (not show in the figures) to effect the selection.

Database of Images 110

With reference to FIG. 2, in a specific example of implementation, the apparatus 120 includes a database of images 110 having a plurality of entries associated to respective threats that the system 100 (shown in FIG. 1) is designed to detect.

In a non-limiting implementation, for each entry in the database 110 associated to a threat, at least one image (hereinafter referred to as a “target image”) is provided in the database of images 110. The format of the target images will depend upon the image processing algorithm implemented by the automated threat detection processor 106. More specifically, the format of the target images is such that a comparison operation can be performed by the automated threat detection processor 106 between a target image in the database 1 10 and data conveying an image of contents of the receptacle 104 generated by the image generation apparatus 102 (shown in FIG. 1). In specific examples of implementation, the images in the database of target images 110 may be actual x-ray images of objects or may be a representation of contours of objects for example.

Optionally, for each entry associated to a threat, a set of images is provided in the database of images 110. For example, images depicting an object in various orientations may be provided.

Optionally still, for each entry associated to a threat, characteristics of the threat are provided. Such characteristics may include, without being limited to, the name of the threat, its associated threat level, information related to the material composition of the threat, the recommended handling procedure when such a threat is detected and any other suitable information. In a specific implementation, the threat level information associated to the threat conveys the relative threat level of a threat compared to other threats in the database of images 110. For example, a gun would be given a relatively high threat level while a metallic nail file would be given a relatively low threat level and a pocket knife would be given a threat level between that of the nail file and the gun.

In the case of luggage screening (in an airport facility for example) the images are associates to objects which typically constitute potential threats to the safety of the passenger or aircraft.

In the case of mail parcel screening, the images are associates to objects which are typically not permitted to be sent through the mail, such as guns (in Canada) for example, due to registration requirements/permits and so on.

In a non-limiting example of implementation, the database of images 110 includes one or more entries associated to objects which are not prohibited but which may represent potential threats. For example, the presence of a metal plate or a metal canister in a piece of luggage going through luggage security screening is not prohibited in itself However such objects may conceal one or more dangerous objects. As such, it is desirable to be able to detect the presence of such objects in receptacle such as to bring them to the attention of the security screeners.

The specific design and content of the database of images 110 may vary from one implementation to the next without detracting from the spirit of the invention. The design of the database is not critical to the present invention and as such will not be described further here.

Although the database of images 110 has been shown in FIG. 2 to be a component separate from the automated threat detection processor 106, it will be appreciated that in certain embodiments the database of images 110 may be part of automated threat detection processor 106 and that such implementations do not detract from the spirit of the invention. In addition, it will also be appreciated that in certain implementations, a same database of images 110 may be shared between multiple threat detection processors 106.

Automated Threat Detection Processor 106

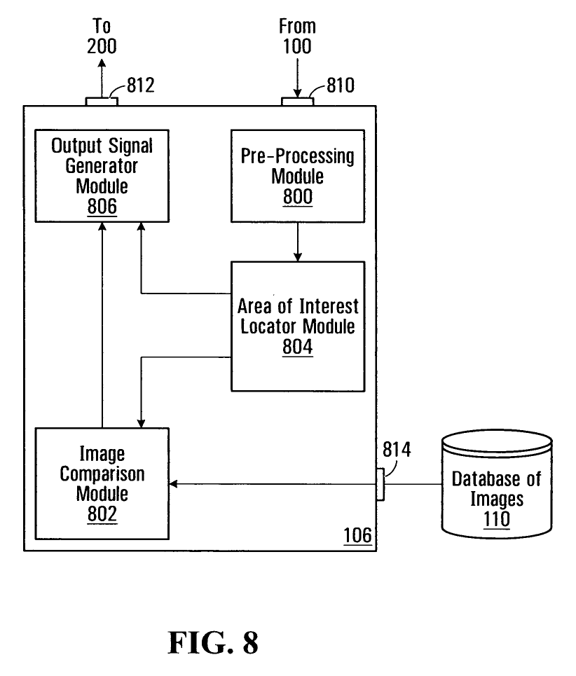

The automated threat detection processor 106 shown in FIG. 2 will now be described in greater detail with reference to FIG. 8. As depicted, the automated threat detection processor 106 includes a first input 810, a second input 814, an output 812 and a processing unit, generally comprising a pre-processing module 800, an area of interest locator module 804, an image comparison module 802 and an output signal generator module 806.

The processing unit of the automated threat detection processor 106 receives data conveying an image of the contents of the receptacle 104 from the first input 810 and processes that image to derive an area of interest in the image and additional information conveying threat information associated to the receptacle 104. The processing unit of the automated threat detection processor 106 generates and releases at output 812 information conveying an area of interest in the image and information conveying the additional threat information.

In a specific example of implementation of the invention, the first input 810 is for receiving data conveying an image of the contents of a receptacle from the image generation apparatus 102 (shown in FIG. 1).

The second input 814 is for receiving images from a database of images 110. It will be appreciated that in embodiments where the database of images 110 is part of automated threat detection processor 106, the second input 814 may be omitted.

The pre-processing module 800 receives the data conveying an image of the contents of a receptacle via the first input 810. The pre-processing module 800 processes the data in order to remove extraneous information from the image and remove noise artefacts in order to obtain more accurate comparison results.

The area of interest locator module 804 is adapted for generating information conveying one or more areas of interest in the image conveying contents of a receptacle received at input 810 based on characteristics intrinsic to that image. In a non-limiting example of implementation where the image is an x-ray image, the characteristics intrinsic to the image include, without being limited to, density information and material class information conveyed by an x-ray type image.

The image comparison module 802 receives information conveying one or more areas of interest from the area of interest locator module 804. The image comparison module 802 is adapted for generating information associated to the one or more areas of interest based on a comparison between the image conveying contents of a receptacle and images in a database of images 110. In a specific example of implementation, the image comparison module 802 receives and processes the areas of interests identified by the area of interest locator module 804 in combination with a plurality of images associated with prohibited objects and/or potential threats to detect a presence of at least one prohibited object and/or threat in the receptacle. In a specific implementation, the plurality of images is stored in a database of images 110.

The output signal generator module 806 receives information conveying one or more areas of interest from the area of interest locator module 804 and additional threat information from the image comparison module 802. The output signal generator module 806 processes this information to generate signals to be released at the output 312 conveying such information.

The output 812 is for releasing information indicating an area of interest in the image potentially containing a threat derived by the area of interest locator module 804 for transmittal to the display control module 200. The output 812 is also for releasing additional threat information associated to the areas of interest for transmittal to the display control module 200, the additional information being derived by the image comparison module 802. The addition information may convey, for example, a level of confidence that the area of interest contains a threat as well as the identity of a prohibited object potentially detected.

The processing unit of the automated threat detection processor 106 receives the data conveying an image of the contents of the receptacle 104 from the first input 810 and processes that image to derive an area of interest in the image and, optionally, to identify a prohibited object in the receptacle 104. The processing unit of the automated threat detection processor 106 generates and releases at output 812 information conveying an area of interest in the image an optionally information conveying the identity of a detected prohibited object.

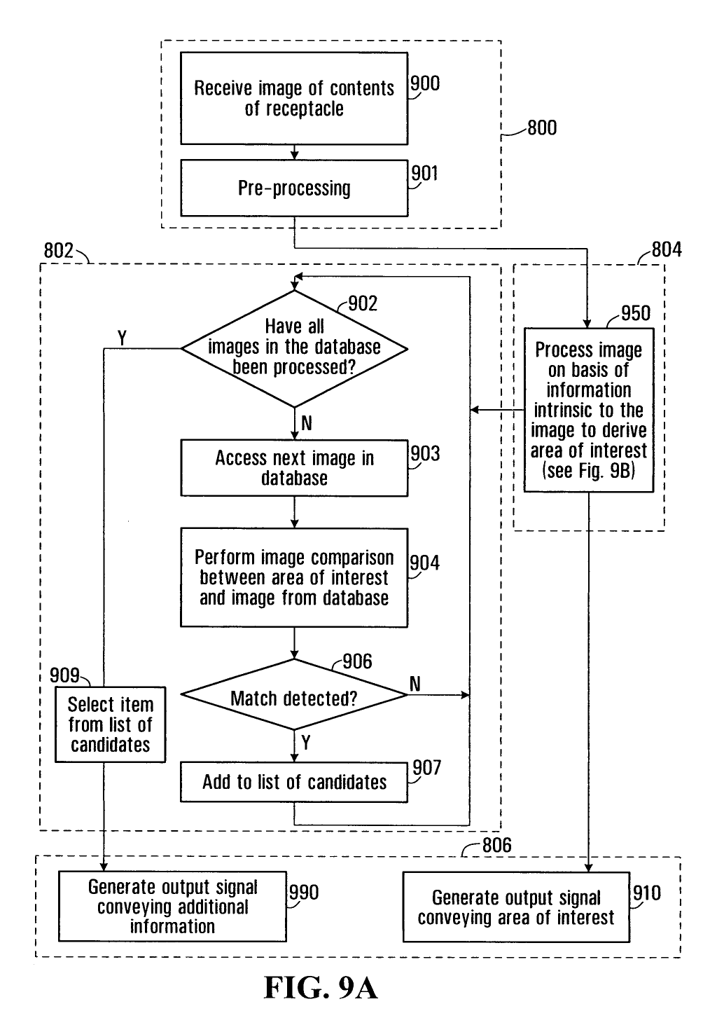

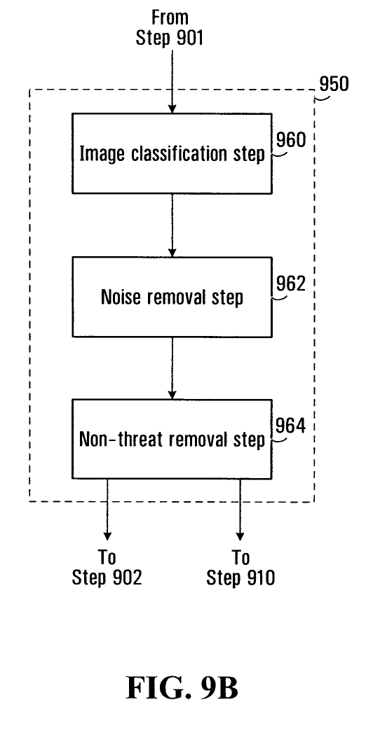

A process implemented by the various functional elements of the processing unit of the automated threat detection processor 106 will now be described with referent to FIGS. 9a and 9b of the drawings.

With reference to FIG. 9a, at step 900, the pre-processing module 800 receives the data conveying an image of the contents of the receptacle 104 via the first input 810. At step 901, the pre-processing module 800 processes the data in order to improve the image, remove extraneous information therefrom and remove noise artefacts in order to obtain more accurate comparison results. The complexity of the requisite level of pre-processing and the related trade-offs between speed and accuracy depend on the application. Examples of pre-processing may include, without being limited to, brightness and contrast manipulation, histogram modification, noise removal and filtering amongst others. It will be appreciated that all or part of the functionality of the pre-processing module 800 may actually be external to the automated threat detection processor 106 (shown in FIG. 8), e.g., it may be integrated as part of the image generation apparatus 102 (shown in FIG. 1) or as an external component. It will also be appreciated that the pre-processing module 800 (and hence step 901) may be omitted in certain embodiments of the present invention without detracting from the spirit of the invention. As part of step 901, the pre-processing module 800 releases data conveying a modified image of the contents of the receptacle 104 for processing by the area of interest locator module 804.

At step 950, the area of interest locator module 804 processes the data conveying the modified image received from the pre-processing module 800 (or the data conveying an image of the contents of the receptacle received via the first input 810) to generate information conveying an area of interest in the image. The area of interest in the image is an area that potentially contains a threat. Any suitable method to determine an area of the image of (or modified image of) contents of a receptacle that potentially contains a threat may be used. In a specific example, the area of interest locator module 804 is adapted for generating information conveying area of interest based on characteristics intrinsic to the input image. In a first specific example of implementation, the image is an x-ray image conveying information related to the material density associated to contents of the receptacle. The area of interest locator module 804 is adapted to process the image and identify areas including a certain concentration of elements characterized by a certain material density, say for example metallic-type elements, and label these areas as areas of interest. Characteristics such as the size of the area exhibited the certain density may also be taken into account to identify an area of interest.

FIG. 9b depicts a specific example of implementation of step 950. As shown, at step 960, an image classification step is performed whereby each pixel of the image received from the pre-processing module 800 (shown in FIG. 8) is assigned to a respective class from a group of classes. The classification of each pixel is based upon information in the image received via the first input 810 such as, for example, information related to the material density. The specific classes and the manner in which a class is assigned to a given pixel are not critical to the invention and any suitable method may be used. Pixels having classes corresponding to certain material densities, such as for example densities corresponding to metallic-type elements, are then provisionally labeled as areas of interest. At step 960, the pixels provisionally labeled as areas of interest are processed to remove noise artifacts. More specifically, the purpose of step 962 is to reduce the number of areas of interest by eliminating from consideration areas that are too small to constitute a significant threat. For instance isolated pixels provisionally classified as areas of interest or groupings of pixels provisionally classified as areas of interest which have an area smaller than a certain threshold area may be discarded by step 962. The result of step 962 is a reduced number of areas of interest. The areas of interests remaining after step 962 are then provided to step 964.

At step 964, the areas of interest in the image remaining after step 952 are processed to remove areas corresponding to identifiable non-threat objects. The purpose of step 964 is to further reduce the number of areas of interest by eliminating from consideration areas corresponding to non-threat objects frequently encountered during luggage security screening. In specific examples of implementation, such identifiable non-threat objects may correspond to non-threat objects frequently encountered during luggage security screening. Examples of such non-threat objects including, without being limited to:
Coins
Belt buckles
Keys
Uniform rectangular regions corresponding to the handle bars of luggage
Binders
Others . . .
   The identification of such non-threat objects in an image may be based on any suitable process. In a non-limiting example, the identification of such non-threat objects is performed using any suitable statistical tools. In a specific example of implementation, non-threat removal is based on shape analysis techniques such as, for example, spatial frequency estimation, Hough transform, Invariant spatial moments, surface and perimeter properties or any suitable statistical classification techniques tuned to minimize the probability of removing a real threat.

It will be appreciated that step 964 is an optional step and that certain implementations of the invention may make use of different criteria to discard an area of interest without detracting from the spirit the invention. Alternatively, certain implementations of the invention may omit step 964 altogether without detraction from the spirit the invention. The result of step 964 is a reduced number of areas of interest, which are then provided to steps 902 and 910 (shown in FIG. 9a).

It will be apparent to the person skilled in the art that methods other that the one depicted in FIG. 9b for identifying areas of interest in an image may be used without detracting from the spirit of the invention.

Returning now to FIG. 9a, at step 910, the output signal generator module 806 receives from the area of interest locator module 804 information conveying one or more areas of interests that were identified at step 950. The output signal generator module 806 then causes this information to be conveying at output 812 (shown in FIG. 8) of the automated threat detection processor 106 (shown in FIG. 8). The information related to the area of interest conveys positioning information associated to a potential threat within the image received at input 810 (shown in FIG. 8). The positioning information may be conveyed in any suitable format. In a non-limiting example, the information may include a plurality of (X,Y) pixel locations defining an area in the image of the contents of a receptacle. In another non-limiting example of implementation, the information may include an (X,Y) pixel location conveying the center of an area in the image.

Continuing with FIG. 9a, while the output signal generator module 806 is performing step 910, the comparison module 802 initiates step 902. At step 902, the image comparison module 802 verifies whether there remain any unprocessed target images in the database of images 110 (shown in FIG. 8). In the affirmative, the image comparison module 802 proceeds to step 903 where the next target image is accessed and the image comparison module 802 then proceeds to step 904. If at step 902 all target images in the database of images 110 (shown in FIG. 8) have been processed, the image comparison module 802 proceeds to step 909, which will be described later below.

At step 904, the image comparison module 802 compares the area of interest identified at step 950 by the area of interest locator module 804 against the image accessed at step 903 to determine whether a match exists. The comparison performed will depend upon the type of images in the database of images 110 (shown in FIG. 8) and may be effected using any suitable image processing algorithm. Examples of algorithms that can be used to perform image processing and comparison include without being limited to:

A—Image Enhancement
Brightness and contrast manipulation
Histogram modification
Noise removal
Filtering

B—Image Segmentation
Thresholding
   Binary or multilevel
   Hysteresis based
   Statistics/histogram analysis
Clustering
Region growing
Splitting and merging
Texture analysis
Blob labeling

C—General Detection
Template matching
Matched filtering
Image registration
Image correlation
Hough transform

D—Edge Detection
Gradient
Laplacian

E—Morphological Image Processing
Binary
Grayscale
Blob analysis

F—Frequency Analysis
Fourier Transform

G—Shape Analysis, Form Fitting and Representations
Geometric attributes (e.g. perimeter, area, euler number, compactness)
Spatial moments (invariance)
Fourier descriptors
B-splines
Polygons
Least Squares Fitting

H—Feature Representation and Classification
Bayesian classifier
Principal component analysis
Binary tree
Graphs
Neural networks
Genetic algorithms

The above algorithms are well known in the field of image processing and as such will not be described further here.

In a specific example of implementation, the image comparison module 802 includes an edge detector to perform part of the comparison at step 904. In another specific example of implementation, the comparison performed at step 904 includes applying a form fitting processing between the image (or modified image) of contents of the receptacle and the images in the database 110 (shown in FIG. 8). In this specific implementation, the database 110 (shown in FIG. 8) includes images of contours of objects. In another specific example of implementation, the comparison performed at step 904 includes effecting a correlation operation between the image (or modified image) of contents of the receptacle and the target images in the database 110 (shown in FIG. 8). In a specific example of implementation, the correlation operation is performed by an optical correlator. In an alternative example of implementation, the correlation operation is performed by a digital correlator. In yet another implementation, a combination of methods is used to effect the comparison of step 904. The results of the comparisons are then combined to obtain a joint comparison result.

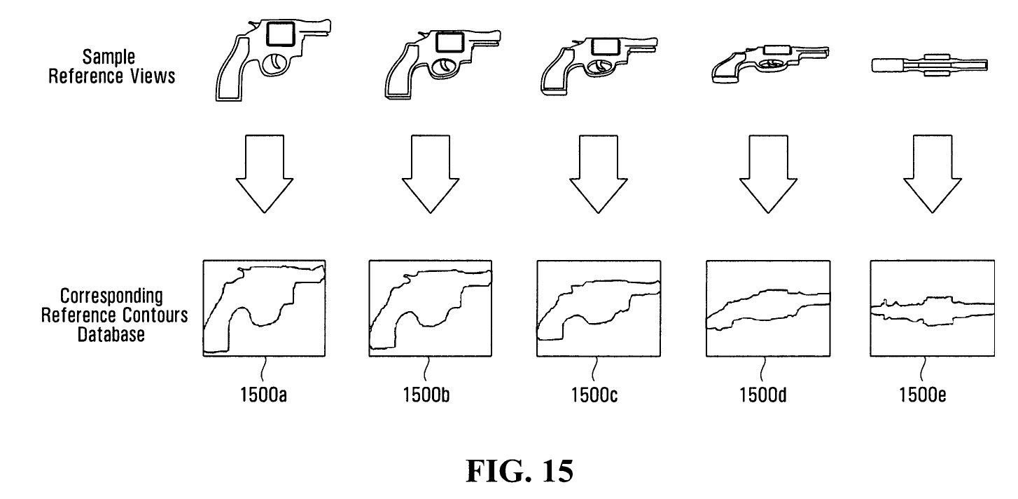

In a specific practical example of implementation of the invention, the database 110 includes a plurality of contours associate to respective objects that the system 100 (shown in FIG. 1) is designed to detect. FIG. 15 of the drawings provides a graphical illustration of a set of contour images 1500a-e that may be included in the database 110 in accordance with this specific example of implementation of the invention. The comparison at step 904 performed by image comparison module 802 is adapted for processing an area of interest identified at step 950 based on a contour in the database 100 using a least-squares fit process. As part of the least-squares fit process, a score providing an indication as to how well the contour in the database fits the shape of the area of interest is also generated. Optionally, as part of the least-squares fit process, a scale factor (S) providing an indication as to the change in size between the contour in the database and the area of interest is also generated. The process of least-squares fit as well as determining a scale factor is well-known in the field of image processing and as such will not be described further here.

The result of step 904 is a score associated to the image of the database accessed at step 903, the score conveying a likelihood that the image of the database is a match to the area of interest being considered.

The image comparison module 802 then proceeds to step 906 where the result of the comparison effected at step 904 is processed to determine whether a match exists between the image (or modified image) of the contents of receptacle 104 and the target image. A likely match is detected of the score obtained by the comparison at step 904 is above a certain threshold score. This score can also be considered as the confidence level associated to detection of a likely match. In the absence of a likely match, the image comparison module 802 returns to step 902. In response to detection of a likely match, the image comparison module 802 proceeds to step 907. At step 907, the image of the database 110 (shown in FIG. 8) against which the area of interest was just processed at step 904 and 906 is added to a candidate list along with its score. The image comparison module 802 then returns to step 902 to continue processing with respect to the next target image.

At step 909, which is initiated once all the images in the database 110 have been processed, the image comparison module 802 processes the candidate list to select therefrom at least one best likely match. The selection criteria may vary from one implementation to the other but will typically be based upon a scores associated to the candidates in the list of candidates. The best candidate is then released to the output signal generator module 806, which proceeds to implement step 990.

It will be appreciated that the steps performed by the image comparison module 802, namely steps 902 903 904 906 907 and 909 are performed for each areas of interest identified by the area of interest locator module 804 at step 950. In cases where the area of interest locator module 804 has identified several areas of interest in the image, the image comparison module 802 may process areas of interest sequentially in accordance with steps 902 903 904 906 907 and 909 or, alternatively, may process multiple areas of interest in parallel each in accordance with steps 902 903 904 906 907 and 909. In cases where the multiple areas of interest are processed in parallel, the image comparison module 802 is configures with the required hardware/software components for enabling such parallel processing of the areas of interest. The rational behind processing the areas of interests in parallel is that different areas of interest will likely be associated to different potential threats and as such can be processed independently from one another.

At step 990, the output signal generator module 806 generates information conveying additional information associated to the region of interest. Such addition information may include, without being limited to, a level of confidence that the area of interest contains a threat, an identification of a threat potentially detected in the image and/or a recommended handling procedure. The additional information is then released at output 812. The identification of a threat may be derived based on the best candidate provided at step 909. The level of confidence may be derived based on the score associated to the best candidate provided at step 909. In a specific example of implementation, the recommended handling procedure is derived based on the level of confidence (or score) and a pre-determined set of rules guiding the recommended handling procedure. Optionally still other information associated to the best candidate provided at step 909 may be generated by the output signal generator module 806 at step 990. Such information may be derived from the database of images 110 and may include information conveying characteristics of the best candidate identified. Such characteristics may include, without being limited to, the name of the threat (e.g. “gun”), its associated threat level, the recommended handling procedure when such a threat is detected and any other suitable information.

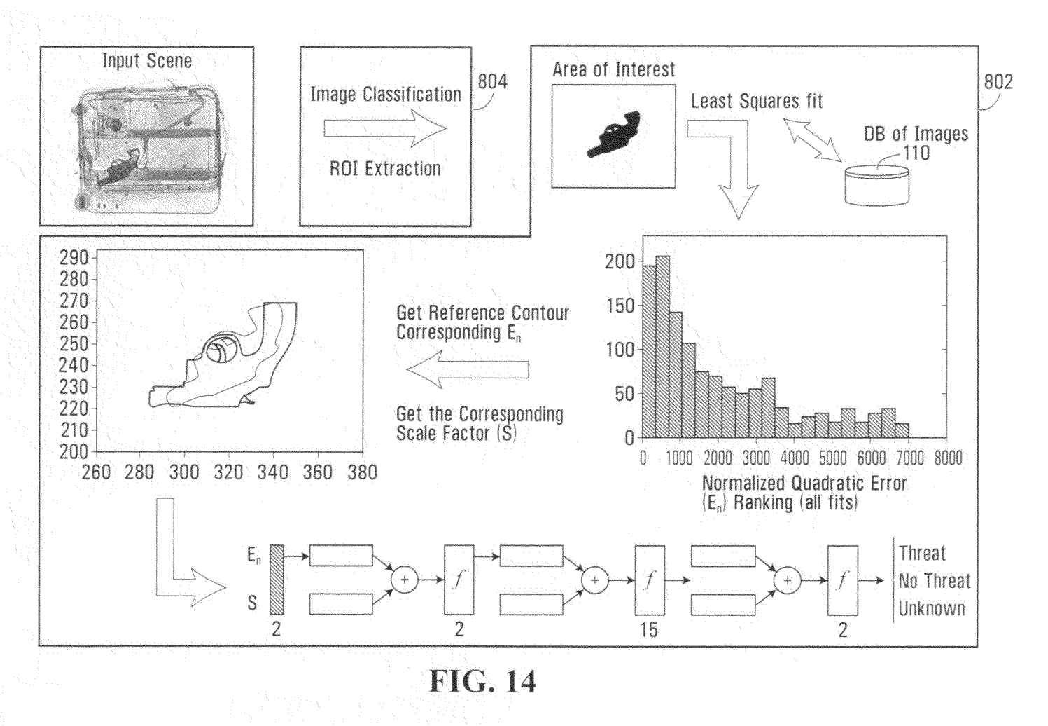

FIG. 14 of the drawings summarizes graphically the steps performed by the area of interest locators module 804 and the image comparison module 802 (both shown in FIG. 8) accordance with an alternative specific example of implementation of the invention. In the embodiment depicted, area of interest locator module 804 processes the input scene image to identify therein an area of interest. Subsequently, the image comparison module 802 applies a least squares fit process for each contour in the database 110 and derives an associated quadratic error data element and a scale factor data element for each contour. The image comparison module 802 then makes use of a neural network to determine the likelihood (of confidence level) that the identified area of interest contains a threat. In the embodiment depicted, the neural network makes use of the quadratic errors as well as the scale factor generated as part of the least squares fit process for each contour in the database 110 to derive a level of confidence that the area of interest contains a threat. More specifically, the neural network, which was previously trained using a plurality of images and contours, is operative for classifying the area of interest identified by the interest locator module 804 as either containing a threat, as containing no threat or as unknown. In other words, for each class in the following set of classes {threat, no threat, unknown} a likelihood value conveying the likelihood that the area of interest belongs the class is derived by the neural network. The resulting likelihood values are then provided to the output signal generator module 806 (shown in FIG. 8). The likelihood that the area of interest belongs to the “threat” class may be used, for example, to derive the information displayed by the threat probability scale 590 (shown in FIG. 5c).

In cases where multiple areas or interests have been identified, the image comparison module 802 processes each area of interest independently in the manner described above to derive a respective level of confidence that the area of interest contains a threat. The levels of confidence for the multiple areas of interest are then combined to derive a combined level of confidence conveying a level of confidence that the overall image of the contents of the receptacle generated by the image generation apparatus 102 (shown in FIG. 1) contains a threat. The manner in which the levels of confidence for the respective areas of interest may be combined to derive the combined level of confidence may vary from one implementation to the other without detracting from the spirit of the invention. For example, the combined level of confidence may be the level of confidence corresponding to the confidence level of an area of interest associated to the highest level of confidence. For example, take an image in which three (3) areas of interests were identified and that these three areas of interest were assigned 50%, 60% and 90% respectively as levels of confidence of containing a threat. The combined level of confidence assigned to the image would be selected as 90% corresponding to the highest level of confidence.

Alternatively, the combined level of confidence may be a weighted sum of the confidence levels associated to the areas of interest. Referring to the same example, with an image in which three (3) areas of interests were identified and that these three areas of interest were assigned 50%, 60% and 90% respectively as levels of confidence of containing a threat. The combined level of confidence assigned to the image in this case may be expressed:

Combined Level of confidence=w₁*90%+w₂*60%+w₃*50%

Where w₁, w₂ and w₃ are respective weights. In practical implementations:

1≧w₁>w₂>w₃≧0

and

Combined Level of confidence=Lesser of {100%; w₁*90%+w₂*60%+w₃*50%}

It will be appreciated by the person skilled in the art that of approached for generating a combined level of confidence for the image may be envisaged without detracting from the spirit of the invention and that the above examples have been presented for the purpose of illustration only.

### Alternative Embodiment

### Screening of Persons

Although the above-described screening system was described in connection with screening of receptacles, the concepts described above can also be applied to the screening of people.

For example, in an alternative embodiment, a system for screening people is provided. The system includes components similar to those described in connection with the system depicted in FIG. 1. In a specific example of implementation, the image generation apparatus 102 is configured to scan a person and possibly to scan the person along various axes and/or views to generate multiple images associated to the person. The image or images associated with the person convey information related to the objects carried by the person. Each image is then processed in accordance with the method described in the present specification to facilitate visual identification of a prohibited object on the person.

Optionally, in the case of a system for screening people, database of images 110 (shown in FIG. 2) may further include entries associated to objects that do not represent a potential threat. Such entries may be used to detect objects commonly carried by people such as cell-phones, watches and rings, for example, which are not threatening. Advantageously, by identifying such objects unnecessary manual verifications can be avoided.

### Specific Physical Implementation

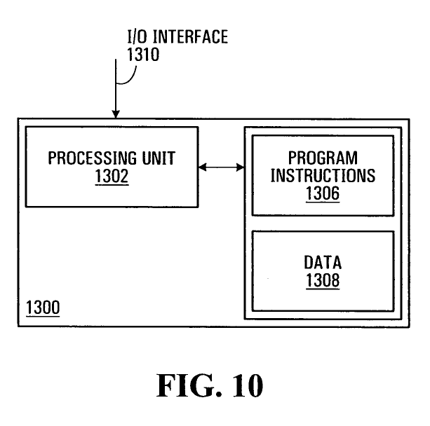

Certain portions of the display control module 200 (shown in FIG. 3) can be implemented on a general purpose digital computer 1300, of the type depicted in FIG. 10, including a processing unit 1302 and a memory 1304 connected by a communication bus. The memory includes data 1308 and program instructions 1306. The processing unit 1302 is adapted to process the data 1308 and the program instructions 1306 in order to implement the functional blocks described in the specification and depicted in the drawings. The digital computer 1300 may also comprise an I/O interface 1310 for receiving or sending data elements to external devices.

Similarly, certain portions of the automated threat detection processor 106 (shown in FIG. 8) can also be implemented on a general purpose digital computer having a similar structure as that described in connection with FIG. 10.

It will be appreciated that the automated threat detection processor 106 and the display control module 200 depicted in FIG. 2 may also be implemented on a same general-purpose digital computer having a similar structure as that described in connection with FIG. 10.

Alternatively, the above-described display control module 200 and automated threat detection processor 106 (shown in FIG. 3) can be implemented on a dedicated hardware platform where electrical/optical components implement the functional blocks described in the specification and depicted in the drawings. Specific implementations may be realized using ICs, ASICs, DSPs, FPGA, an optical correlator, digital correlator or other suitable hardware platform.

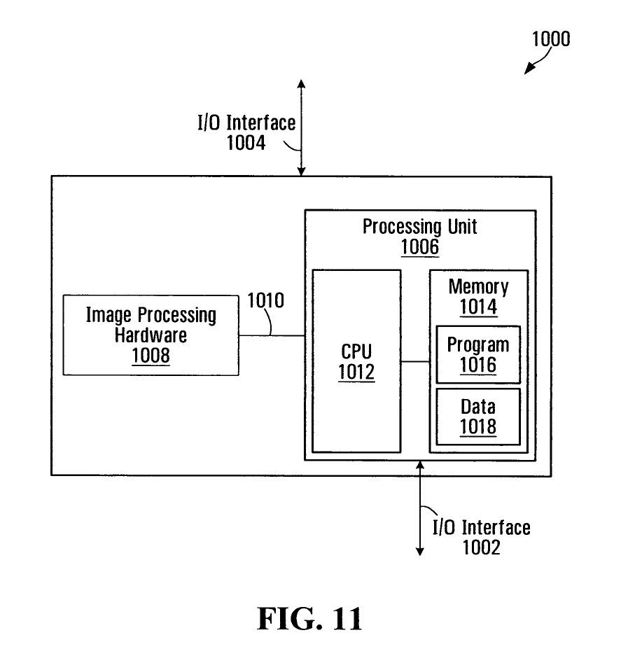

Other alternative implementations of the automated threat detection processor 106 and the display control module 200 can be implemented as a combination of dedicated hardware and software such as apparatus 1000 of the type depicted in FIG. 11. As shown, such an implementation comprises a dedicated image processing hardware module 1008 and a general purpose computing unit 1006 including a CPU 1012 and a memory 1014 connected by a communication bus. The memory includes data 1018 and program instructions 1016. The CPU 1012 is adapted to process the data 1018 and the program instructions 1016 in order to implement the functional blocks described in the specification and depicted in the drawings. The CPU 1012 is also adapted to exchange data with the dedicated image processing hardware module 1008 over communication link 1010 to make use of the image processing capabilities of the dedicated image processing hardware module 1008. The apparatus 1000 may also comprise I/O interfaces 1002 1004 for receiving or sending data elements to external devices.

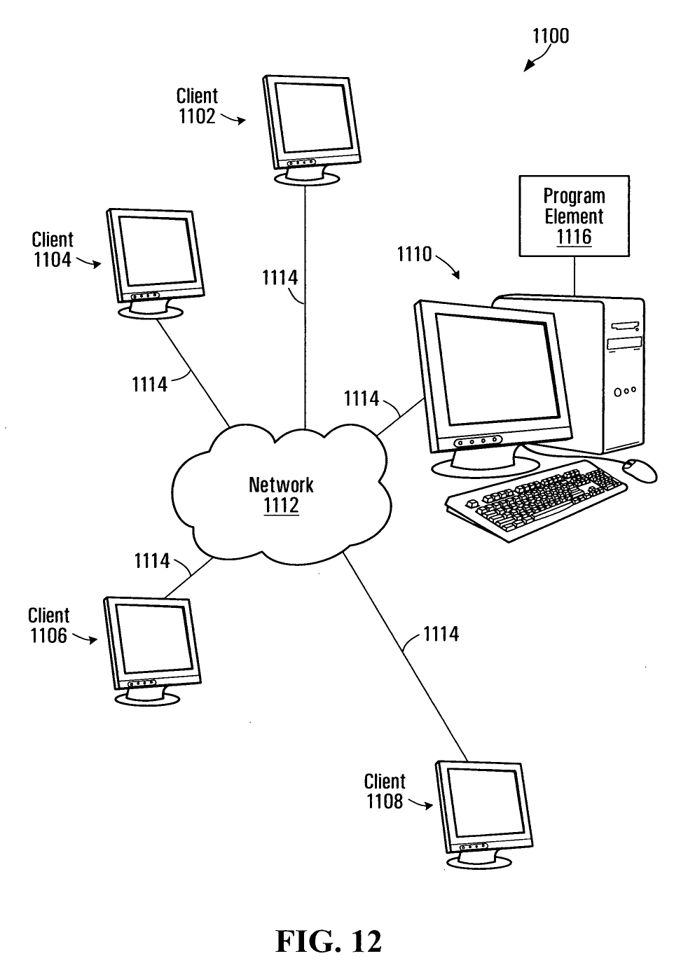

It will be appreciated that the screening system 100 (depicted in FIG. 1) may also be of a distributed nature where the images of contents of receptacles are obtained at one location or more locations and transmitted over a network to a server unit implementing the method implemented by apparatus 120 (shown in FIG. 1) described above. The server unit may then transmit a signal for causing a display unit to display information to the user. The display unit may be located in the same location where the images of contents of receptacles were obtained or in the same location as the server unit or in yet another location. In a non-limiting implementation, the display unit is part of a centralized screening facility. FIG. 12 illustrates a network-based client-server system 1100 for system for screening receptacles. The client-server system 1100 includes a plurality of client systems 1102, 1104, 1106 and 1108 connected to a server system 1110 through network 1112. The communication links 1114 between the client systems 1 102, 1104, 1106 and 1108 and the server system 1110 can be metallic conductors, optical fibers or wireless, without departing from the spirit of the invention. The network 1112 may be any suitable network including but not limited to a global public network such as the Internet, a private network and a wireless network. The server 1110 may be adapted to process and issue signals concurrently using suitable methods known in the computer related arts.

The server system 1110 includes a program element 1116 for execution by a CPU. Program element 1116 includes functionality to implement the functionality of apparatus 120 (shown in FIGS. 1 and 2) described above, including functionality for displaying information associated to a receptacle and for facilitating visual identification of a threat in an image during security screening. Program element 1116 also includes the necessary networking functionality to allow the server system 1110 to communicate with the client systems 1102, 1104, 1106 and 1108 over network 1112. In a specific implementation, the client systems 1102, 1104, 1106 and 1108 include display devices responsive to signals received from the server system 1110 for displaying a user interface module implemented by the server system 11 10.

Although the present invention has been described in considerable detail with reference to certain preferred embodiments thereof, variations and refinements are possible without departing from the spirit of the invention. Therefore, the scope of the invention should be limited only by the appended claims and their equivalents.

1. A method for facilitating visual identification of a threat in an image during security screening, said method comprising:
a. receiving data conveying an image of the contents of a receptacle derived from an apparatus that scans the receptacle with penetrating radiation;
b. processing the data conveying the image of the contents of the receptacle to derive an area of interest in the image, the area of interest potentially containing a threat;
c. displaying on a display device first threat information conveying the area of interest in the image while processing the area of interest in the image using an automated threat detection processor to derive second threat information associated to the receptacle;
d. displaying on the display device the second threat information, the second threat information being displayed subsequently to the displaying of the first threat information.

2. A method as defined in claim 1, said method comprising displaying on the display device the image of the contents of the receptacle.

3. A method as defined in claim 1, wherein the area of interest in the image is derived substantially based on information intrinsic to the image of the contents of the receptacle.

4. A method as defined in claim 1, wherein the second threat information conveys a level of confidence that the receptacle contains a threat.

5. A method as defined in claim 1, wherein the second threat information is derived at least in part based on a database of images associated with potential threats.

6. A method as defined in claim 5, wherein the second threat information conveys identification information associated to a prohibited object potentially located in the receptacle.

7. A method as defined in claim 1, said method comprising processing the area of interest in the image at least in part based on a database of contour images to derive second threat information associated to the receptacle.

8. A method as defined in claim 1, wherein the second threat information conveys a perceived threat level associate with the receptacle.

9. A method as defined in claim 1, wherein said method comprises:
a. processing the data conveying the image of the contents of the receptacle to derive a plurality of areas of interest in the image, each area of interest in said plurality of areas of interests potentially containing a threat;
b. displaying on the display device first threat information conveying the plurality of areas of interest in the image.

10. A method as defined in claim 9, wherein said method comprises processing at least two areas of interest in said plurality of areas of interests in parallel to derive second threat information associated to the receptacle.

11. A method as defined in claim 1, said method comprising:
a. processing the image at least in part based on the area of interest in the image to generate an enhanced image in which portions outside the area of interest are visually de-emphasized;
b. displaying the enhanced image.

12. An apparatus for facilitating visual identification of a threat in an image during security screening, said apparatus comprising:
a. an input for receiving data conveying an image of the contents of a receptacle derived from an apparatus that scans the receptacle with penetrating radiation;
b. a processing unit in communication with the input, said processing unit being operative for:
i. processing the data conveying the image of the contents of the receptacle to derive an area of interest in the image, the area of interest potentially containing a threat;
ii. displaying on a display device first threat information conveying the area of interest in the image while processing the area of interest in the image to derive second threat information associated to the receptacle;
iii. displaying on the display device the second threat information, the second threat information being displayed subsequently to the displaying of the first threat information.

13. An apparatus as defined in claim 12, wherein said processing unit is operative for displaying on the display device the image of the contents of the receptacle.

14. An apparatus as defined in claim 12, wherein the area of interest in the image is derived substantially based on information intrinsic to the image of the contents of the receptacle.

15. An apparatus as defined in claim 12, wherein the second threat information conveys a level of confidence that the receptacle contains a threat.

16. An apparatus as defined in claim 12, wherein the second threat information is derived at least in part based on a database of images associated with potential threats.

17. An apparatus as defined in claim 16, wherein the second threat information conveys identification information associated to a prohibited object potentially located in the receptacle.

18. An apparatus as defined in claim 12, wherein said processing unit is operative for processing the area of interest in the image at least in part based on a database of contour images to derive second threat information associated to the receptacle.

19. An apparatus as defined in claim 12, wherein the second threat information conveys a perceived threat level associate with the receptacle.

20. An apparatus as defined in claim 12, wherein said processing unit is operative for:
a. processing the data conveying the image of the contents of the receptacle to derive a plurality of areas of interest in the image, each area of interest in said plurality of areas of interests potentially containing a threat;
b. displaying on the display device first threat information conveying the plurality of areas of interest in the image.

21. An apparatus as defined in claim 20, wherein said processing unit is operative for processing at least two areas of interest in said plurality of areas of interests in parallel to derive second threat information associated to the receptacle.

22. An apparatus as defined in claim 12, wherein said processing unit is operative for:
a. processing the image at least in part based on the area of interest in the image to generate an enhanced image in which portions outside the area of interest are visually de-emphasized;
b. displaying on the display device the enhanced image.

23. An apparatus as defined in claim 12, wherein said processing unit comprises:
a. an automated threat detection processor in communication with said image generation apparatus, said automated threat detection processor being adapted for deriving;
i. the area of interest in the image; and
ii. the second threat information associated to the receptacle;
b. a display control module in communication with said automated threat detection processor and said display module, said display control module implementing a user interface module for facilitating visual identification of a threat in an image during security screening, said display control module being operative for:
i. displaying on the display device first threat information conveying the area of interest in the image;
ii. displaying on the display device the second threat information, the second threat information being displayed subsequently to the displaying of the first threat information.

24. An apparatus as defined in claim 12, wherein said processing unit comprises
a. an automated threat detection processor in communication with said image generation apparatus, said automated threat detection processor being adapted for:
i. receiving the data conveying the image of contents of the receptacle;
ii. processing the data conveying the image of the contents of the receptacle to derive the area of interest in the image;
iii. releasing data conveying the area of interest in the image;
iv. processing the area of interest in the image to derive the second threat information associated to the receptacle;
v. releasing the second threat information;
b. a display control module in communication with said automated threat detection processor and said display module, said display control module implementing a user interface module for facilitating visual identification of a threat in an image during security screening, said display control module being operative for:
i. receiving the data conveying the area of interest in the image released by the automated threat detection processor;
ii. displaying on a display device first threat information conveying the area of interest in the image;
iii. receiving the second threat information released by the automated threat detection processor;
iv. displaying on the display device the second threat information, the second threat information being displayed subsequently to the displaying of the first threat information.

25. A computer readable storage medium storing a program element suitable for execution by a computing apparatus for facilitating visual identification of a threat in an image during security screening, said computing apparatus comprising:
a. a memory unit;
b. a processor operatively connected to said memory unit, said program element when executing on said processor being operative for:
i. receiving data conveying an image of the contents of a receptacle derived from an apparatus that scans the receptacle with penetrating radiation;
ii. processing the data conveying the image of the contents of the receptacle to derive an area of interest in the image, the area of interest potentially containing a threat;
iii. displaying on a display device first threat information conveying the area of interest in the image while processing the area of interest in the image to derive second threat information associated to the receptacle;
iv. displaying on the display device the second threat information, the second threat information being displayed subsequently to the displaying of the first threat information.

26. A computer readable storage medium as defined in claim 25, said program element when executing on said processor being operative for displaying on the display device the image of the contents of the receptacle.

27. A computer readable storage medium as defined in claim 25, wherein the area of interest in the image is derived substantially based on information intrinsic to the image of the contents of the receptacle.

28. A computer readable storage medium as defined in claim 25, wherein the second threat information conveys a level of confidence that the receptacle contains a threat.

29. A computer readable storage medium as defined in claim 25, wherein the second threat information is derived at least in part based on a database of images associated with potential threats.

30. A computer readable storage medium as defined in claim 29, wherein the second threat information conveys identification information associated to a prohibited object potentially located in the receptacle.

31. A computer readable storage medium as defined in claim 25, said program element when executing on said processor being operative for processing the area of interest in the image at least in part based on a database of contour images to derive second threat information associated to the receptacle.

32. A computer readable storage medium as defined in claim 25, wherein the second threat information conveys a perceived threat level associate with the receptacle.

33. A computer readable storage medium as defined in claim 25, wherein said program element when executing on said processor being operative for:
a. processing the data conveying the image of the contents of the receptacle to derive a plurality of areas of interest in the image, each area of interest in said plurality of areas of interests potentially containing a threat;
b. displaying on the display device first threat information conveying the plurality of areas of interest in the image.

34. A computer readable storage medium as defined in claim 33, wherein said program element when executing on said processor being operative for processing at least two areas of interest in said plurality of areas of interests in parallel to derive second threat information associated to the receptacle.

35. A computer readable storage medium as defined in claim 25, said program element when executing on said processor being operative for:
a. processing the image at least in part based on the area of interest in the image to generate an enhanced image in which portions outside the area of interest are visually de-emphasized;
b. displaying the enhanced image.

36. A system for facilitating detection of a threat in a receptacle, comprising:
a. an image generation apparatus suitable for scanning a receptacle with penetrating radiation to generate data conveying an image of contents of the receptacle;
b. a display device;
c. an apparatus for facilitating visual identification of a threat in an image during security screening, said apparatus being in communication with said image generation apparatus and with said display device, said apparatus comprising:
i. an input for receiving data conveying an image of the contents of a receptacle derived from the image generation apparatus;
ii. a processing unit in communication with the input, said processing unit being operative for:
1. processing the data conveying the image of the contents of the receptacle to derive an area of interest in the image, the area of interest potentially containing a threat;
2. displaying on the display device first threat information conveying the area of interest in the image while processing the area of interest in the image to derive second threat information associated to the receptacle;
3. displaying on the display device the second threat information, the second threat information being displayed subsequently to the displaying of the first threat information.

37. A client-server system for implementing a graphical user interface module for facilitating visual identification of a threat in an image during security screening, said client-server system comprising a client system and a server system, said client system and said server system operative to exchange messages over a data network, said server system storing a program element for execution by a CPU, said program element comprising:
a. first program element component executed on said server system for receiving data conveying an image of the contents of a receptacle derived from an apparatus that scans the receptacle with penetrating radiation;
b. second program element component executed on said server system for processing the data conveying the image of the contents of the receptacle to derive an area of interest in the image, the area of interest potentially containing a threat;
c. third program element component executed on said server system for sending a message to said client system for causing a display device associated with said client system to display first threat information conveying the area of interest in the image;
d. fourth program element component executed on said server system for processing the area of interest in the image to derive second threat information associated to the receptacle;
e. fifth program element component executed on said server system for sending a message to said client system for causing a display device associated with said client system to display the second threat information, the second threat information being caused to be displayed subsequently to the displaying of the first threat information.

38. A client-server system as defined in claim 37, wherein the data network is the Internet.

39. An apparatus for facilitating visual identification of a threat in an image during security screening, said apparatus comprising:
a. means for receiving data conveying an image of the contents of a receptacle derived from an apparatus that scans the receptacle with penetrating radiation;
b. means for processing the data conveying the image of the contents of the receptacle to derive an area of interest in the image, the area of interest potentially containing a threat;
c. means for displaying on a display device first threat information conveying the area of interest in the image while processing the area of interest in the image to derive second threat information associated to the receptacle;
d. means for displaying on a display device the second threat information, the second threat information being displayed subsequently to the displaying of the first threat information.

40. A method for facilitating visual identification of a threat in an image during security screening, said method comprising:
a. receiving data conveying an image of the contents of a receptacle derived from an apparatus that scans the receptacle with penetrating radiation;
b. processing the data conveying the image of the contents of the receptacle to derive a sequence of information elements conveying threat information associated to the receptacle, said sequence of information elements conveying at least first threat information and second threat information;
c. incrementally displaying on a display device threat information associated to the receptacle at least in part based on the sequence of information elements, the incrementally displaying being effected such that said first threat information is displayed on the display device while said second threat information is being derived.
